(19) United States
(12) Patent Application Publication
(10) Pub. No.: US 2025/0062064 A1
(43) Pub. Date: Feb. 20, 2025

(54) HYBRID CONSTRUCTION TRANSFORMER

(71) Applicant: Murata Manufacturing Co., Ltd., Nagaokakyo-shi (JP)

(72) Inventor: Kapila WARNAKULASURIYA, Milton Keynes (GB)

(21) Appl. No.: 18/934,496

(22) Filed: Nov. 1, 2024

Related U.S. Application Data
(63) Continuation of application No. PCT/GB2022/053255, filed on Dec. 15, 2022.

(30) Foreign Application Priority Data
May 5, 2022 (GB) 2206598.1

(51) Int. Cl. H01F 27/22; H01F 27/02; H01F 27/24; H01F 27/28

(52) U.S. Cl. CPC H01F 27/22; H01F 27/02; H01F 27/24; H01F 27/28

(57) ABSTRACT

An electrical transformer includes a transformer core; a winding arranged around the transformer core, the winding including a primary coil and a secondary coil encased in a potting material; and a housing surrounding the transformer core and the winding. The housing includes a plurality of thermal conductors in thermal contact with the winding and/or the transformer core, and the housing including one or more open sides such that the winding is exposed.

### CROSS REFERENCE TO RELATED APPLICATIONS

This application claims the benefit of priority to United Kingdom Patent Application No. 2206598.1 filed on May 5, 2022 and is a Continuation Application of PCT Application No. PCT/GB2022/053255 filed on Dec. 15, 2022. The entire contents of each application are hereby incorporated herein by reference.

### BACKGROUND OF THE INVENTION

### 1. Field of the Invention

This application relates to electrical transformers, and in particular, to hybrid construction transformers each with a semi-potted and semi-open construction.

### 2. Description of the Related Art

Known pdqb winding technology makes it possible to achieve the theoretically minimum level of high frequency conductor losses in high-power, high-frequency transformers (which typically have operating parameters above 10 kW and 10 kHz). Known pdqb technology is described in UK patent application publication GB2574481A and international patent application publication WO 2019/234453 A1, which are hereby incorporated by reference in their entirety.

Further, known thermal management technology makes it possible to extract heat generated in compact transformer structures effectively. Known thermal management technology is described in UK patent application publications GB2597670A and GB2597470A, and international patent application publications WO 2022/023744 A1 and WO 2022/018436 A1, which are hereby incorporated by reference in their entirety.

FIG. 1 shows an example of an existing pdqb transformer 100. The transformer 100 includes a transformer core and a set of windings contained within a closed housing. In other words, the transformer 100 has a closed construction. Known transformers, such as the transformer 100 of FIG. 1, use either completely potted constructions or completely unpotted open constructions. Both of these options have associated disadvantages.

Moreover, there are a number of parameters, approximately 40, that affect the design of a high-power, high-frequency transformer. These include the primary voltage, secondary voltage, rated power (continuous), operating frequency, primary inductance, secondary inductance, leakage inductance, primary DC resistance, secondary DC resistance, primary AC resistance, secondary AC resistance, and the interwinding capacitance. Different parameters have a different degree of significance for different applications of the transformer, making it difficult to provide a single construction or even a small group of different constructions that will be suitable for all these applications.

Previous attempts to provide a universal transformer include using different core sizes and/or core assemblies to make the transformer suitable for different voltage and frequency levels.

A power level in the range of about 30 kW to about 70 kW, including about 50 kW, is desirable for many applications. A 50-kW power level is a reasonable power level that would cover over 90% of common applications.

It would be desirable to provide an improved, cost-effective single transformer construction applicable to many applications, in particular, a construction where only minor adjustments are needed to make the transformer universal for the above-mentioned power level for a range of voltages and frequencies of operation.

### SUMMARY OF THE INVENTION

According to a first example embodiment of the present invention, an electrical transformer includes a transformer core; a winding arranged around the transformer core, the winding including a primary coil and a secondary coil encased in a potting material; and a housing surrounding the transformer core and the winding. The housing includes a plurality of thermal conductors in thermal contact with the winding and/or the transformer core, and the housing includes one or more open sides such that the winding is exposed.

Optionally, the one or more open sides include two open sides located on opposing sides of the housing that expose the winding at both of the opposing sides of the housing.

Optionally, the two open sides expose a portion of each of the plurality of thermal conductors.

Optionally, wherein the electrical transformer is cuboid or substantially cuboid in shape, and each of the one or more open sides extends across an entire surface of the electrical transformer.

Optionally, the housing includes an upper panel and a lower panel located on opposing sides of the electrical transformer.

Optionally, the upper panel and lower panel extend in planes normal or approximately normal to a winding axis of the winding.

Optionally, the upper panel and lower panel are in contact with the transformer core.

Optionally, the plurality of thermal conductors includes a first set of thermal conductors that extend between the upper panel and the lower panel and are in thermal contact with the upper panel and lower panel.

Optionally, each of the first set of thermal conductors is releasably secured to the upper panel at a first end, and releasably secured to the lower panel at a second end.

Optionally, the plurality of thermal conductors includes a second set of thermal conductors located between the upper panel and the winding, and in thermal contact with the upper panel and the winding, and/or the plurality of thermal conductors includes a third set of thermal conductors located between the lower panel and the winding, and in thermal contact with the lower panel and the winding.

Optionally, each of the second set of thermal conductors is releasably secured to the upper panel, and/or each of the third set of thermal conductors is releasably secured to the lower panel.

Optionally, the electrical transformer further includes one or more additional thermal conductors located against a central portion of the transformer core, wherein each additional thermal conductor extends between the upper panel and the lower panel and is in thermal contact with the upper panel and lower panel, wherein the winding is arranged around the transformer core and the additional thermal conductors.

Optionally, the one or more additional thermal conductors are integral with the winding.

Optionally, the housing includes gaps between the first set of thermal conductors and the third set of thermal conductors, and/or the housing includes gaps between the second set of thermal conductors and the one or more additional thermal conductors.

Optionally, the transformer core includes one or more core layers, wherein each of the one or more core layer includes two closed cores, and each of the two closed cores includes either two U-shaped cores or a U-shaped core and an I-shaped core; a thermally conductive plate that is located between the two closed cores and extends along a winding axis of the winding so as to bisect the one or more core layers; and optionally, when the transformer core includes a plurality of core layers, one or more secondary thermally conductive plates located between the plurality of core layers.

Optionally, the transformer core includes one or more core layers, wherein each one or more core layers includes one closed core including either two U-shaped cores or a U-shaped core and an I-shaped core; a thermally conductive plate that is located on one side of the transformer core and extends along a winding axis of the winding; and optionally, when the transformer core includes a plurality of core layers, one or more secondary thermally conductive plates located between the plurality of core layers.

Optionally, the electrical transformer includes a pair of protrusions extending from the winding and configured to engage with the transformer core, with a portion of the transformer core located between the pair of protrusions when the winding is arranged around the transformer core.

Optionally, the pair of protrusions extend between the winding and the lower panel.

Optionally, the pair of protrusions are defined by the potting material.

Optionally, the plurality of thermal conductors prevents movement of the winding within the housing.

Optionally, the primary coil and the secondary coil each include a first section and a second section, and each of the first and second sections include a first set of turns including a first diameter and a second set of turns including a second diameter; the first diameter is larger than the second diameter; the first section and second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis; the first section and second section of the secondary coil are electrically connected in parallel and are wound around the common winding axis, with the second set of turns of the second section positioned within the first set of turns of the first section, and the second set of turns of the first section positioned within the first set of turns of the second section, when viewed along the common winding axis; and the turns of the primary coil are interleaved with the turns of the secondary coil.

Optionally, the winding further includes a plurality of additional secondary coils, e.g., up to a total of ten secondary coils.

Optionally, the winding includes connection points for the primary coil and secondary coil that extend through the upper panel.

Optionally, the lower panel is a cold plate or is in thermal contact with a cold plate.

Optionally, one or more of the plurality of thermal conductors includes radiating fins.

Optionally, one or more of the plurality of thermal conductors include aluminum, and/or one or more of the plurality of thermal conductors includes at least one outer surface that is colored black.

Optionally, the electrical transformer further includes one or more winding cooling plates, wherein each of the one or more winding cooling plates is in thermal contact with an upper or lower surface of the winding and wherein each of the one or more winding cooling plates is in thermal contact with at least one of the plurality of thermal conductors.

Optionally, the plurality of thermal conductors includes a first pair of thermal conductors located in thermal contact with an upper surface of the winding, and/or the plurality of thermal conductors includes a second pair of thermal conductors located in thermal contact with a lower surface of the winding.

Optionally, the electrical transformer further includes one or more first winding cooling plates located between the upper surface of the winding and the first pair of thermal conductors, and/or one or more winding second cooling plates located between the lower surface of the winding and the second pair of thermal conductors.

Optionally, each winding cooling plate extends in a direction parallel or substantially parallel to the plane of the winding and extends through the transformer core in a direction perpendicular or substantially perpendicular to the plane of the transformer core.

Optionally, each winding cooling plate extends between a pair of thermal conductors positioned on opposing sides of the transformer core.

The electrical transformer of the first example embodiment provides a number of advantages. The semi-open construction enhances the cooling of the transformer core and the winding, while also reducing the weight and the cost of the electrical transformer. Moreover, the electrical transformer is modifiable after installation, thus providing an adaptable transformer that is applicable to many applications, and universal over power ratings in the range of about 50 kW to about 100 kW, for example.

In particular, a simple change of the plurality of thermal conductors (between those with and without radiating fins) and/or a simple change of the lower panel (such as introducing a cooling plate) mean that the transformer can be made suitable for various different forced air cooled, natural convention cooled, or water cooled plate mounted constructions. The winding arrangement can also be changed after initial installation. These modifications are easily performed by, for example, using releasable connections, helping to provide a universal transformer construction.

According to a second example embodiment of the present invention, a winding arrangement for an electrical transformer is provided. The winding arrangement of the second example embodiment is described in the following clauses.

(1) A winding arrangement for an electrical transformer, the winding arrangement including a primary coil and a secondary coil, wherein the primary coil and the secondary coil each include a first section and a second section, and each of the first and second sections include a first set of turns including a first diameter and a second set of turns including a second diameter; the first diameter is larger than the second diameter; the first section and second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis; the first section and second section of the secondary coil are electrically connected in parallel and are wound around the common winding axis, with the second set of turns of the second section positioned within the first set of turns of the first section, and the second set of turns of the first section positioned within the first set of turns of the second section, when viewed along the common winding axis; and the turns of the primary coil are interleaved with the turns of the secondary coil.

(2) The winding arrangement of clause 1, wherein the primary coil is interleaved with the secondary coil such that each turn of the secondary coil is located between two turns of the primary coil when viewed along a direction perpendicular to the common winding axis.

(3) The winding arrangement of clauses 1 or 2, wherein the primary coil is interleaved with the secondary coil such that the turns of the first sets of turns of the primary coil and the turns of the first sets of turns of the secondary coil alternate along the common winding axis, and the turns of the second sets of turns of the primary coil and the turns of the second sets of turns of the secondary coil alternate along the common winding axis.

(4) The winding arrangement of any preceding clause, wherein the primary coil is identical to the secondary coil.

(5) The winding arrangement of clause 4, wherein the secondary coil is rotated by 180° about the common winding axis relative to the primary coil.

(6) The winding arrangement of clause 1, further including one or more additional secondary coils, wherein the one or more additional secondary coils each include a first section and a second section, and each of the first and second sections include a first set of turns including the first diameter and a second set of turns including the second diameter; the first section and second section of each additional secondary coil are electrically connected in parallel and are wound around the common winding axis, with the second set of turns of the second section positioned within the first set of turns of the first section, and the second set of turns of the first section positioned within the first set of turns of the second section, when viewed along the common winding axis; and the turns of the primary coil are interleaved with the turns of the one or more additional secondary coils.

(7) The winding arrangement of clause 6, wherein the primary coil is interleaved with the secondary coil and the one or more additional secondary coils such that each turn of the secondary coil is located between two turns of the primary coil when viewed along a direction perpendicular to the common winding axis and such that each turn of the one or more additional secondary coils is located between two turns of the primary coil when viewed along the plane containing the common winding axis.

(8) The winding arrangement of clauses 6 or 7, wherein the primary coil is interleaved with the secondary coil and the one or more additional secondary coils such that the turns of the first sets of turns of the primary coil and the turns of the first sets of turns of the secondary coil alternate along a first portion of the common winding axis, and the turns of the second sets of turns of the primary coil and the turns of the second sets of turns of the secondary coil alternate along the first portion of the common winding axis; and the turns of the first sets of turns of the primary coil and the turns of the first sets of turns of the one or more additional secondary coils alternate along a second portion of the common winding axis, and the turns of the second sets of turns of the primary coil and the turns of the second sets of turns of the one or more additional secondary coils alternate along the second portion of the common winding axis.

(9) The winding arrangement of any of clauses 6 to 8, wherein the number of turns in the primary coil is greater than or equal to the combined total number of turns in the secondary coil and the one or more additional secondary coils.

(10) The winding arrangement of any of clauses 6 to 9, wherein the winding arrangement includes up to nine additional secondary coils.

(11) The winding arrangement of any of clauses 6 to 10, wherein the secondary coil and the one or more additional secondary coils are stacked such that the secondary coil and the one or more additional secondary coils fully overlap when viewed along the common winding axis.

(12) The winding arrangement of any preceding clause, wherein the primary coil and the secondary coil fully overlap when viewed along the common winding axis.

(13) The winding arrangement of any preceding clause, wherein for each coil a number of turns in the first set of turns of each of the first and second sections of that coil is equal, and a number of turns in the second sets of turns of each of the first and second sections of that coil is equal.

(14) The winding arrangement of any preceding clause, wherein for each section of each coil a number of turns in the first set of turns is equal to a number of turns in the second set of turns of the respective section.

(15) The winding arrangement of any preceding clause, wherein the first sets of turns and the second sets of turns of each coil are concentric about the common winding axis.

(16) The winding arrangement of any preceding clause, wherein the turns of each of the coils includes a rectangular, square, or circular shape about the winding axis, and/or each set of turns is arranged helically around the common winding axis.

(17) The winding arrangement of any preceding clause, wherein each of the coils include aluminum wire.

(18) The winding arrangement of any preceding clause, wherein each of the coils include flat wire.

(19) The winding arrangement of clause 18, wherein the flat wire includes a width of between about 10 mm and about 15 mm, within manufacturing and/or measurement tolerances, and a thickness of between about 0.8 mm and about 1.2 mm, within manufacturing and/or measurement tolerances, e.g., a thickness of about 1 mm.

(20) The winding arrangement of any preceding clause, wherein each of the coils are encased in a potting material.

(21) The winding arrangement of any preceding clause, wherein each coil includes connection terminals extending parallel or substantially parallel to the direction of the common winding axis to allow an electrical connection to be made with that coil.

(22) The winding arrangement of clause 21, wherein the connection terminals of the primary coil and the connection terminals of the secondary coil or coils are located on opposing sides of the winding arrangement.

According to a third example embodiment of the present invention, a winding arrangement for an electrical transformer is provided. The winding arrangement of the third example embodiment is described in the following clauses.

(23) A winding arrangement for an electrical transformer, the winding arrangement including a primary coil and plurality of secondary coils, wherein the primary coil includes a first section and a second section, and each of the first and second sections include a first set of turns including a first diameter and a second set of turns including a second diameter; the first diameter is larger than the second diameter; the first section and second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis; each of the plurality of secondary coils includes a first set of turns including the first diameter and a second set of turns including the second diameter, both wound around the common winding axis; the turns of the primary coil are interleaved with the turns of the plurality of secondary coils.

(24) The winding arrangement of clause 23, wherein the primary coil is interleaved with the secondary coils such that each turn of the plurality of secondary coils is located between two turns of the primary coil when viewed along a direction perpendicular to the common winding axis.

According to a fourth example embodiment of the present invention, an electrical transformer is provided. The electrical transformer of the fourth example embodiment is described in the following clause.

(25) An electrical transformer including a transformer core; and the winding arrangement of any of clauses 1 to 24 arranged around the transformer core.

The winding arrangements of the second and third example embodiments reduce losses caused by the proximity effect due to the interleaving of the primary and secondary coils. Moreover, the winding arrangements allow for multiple secondary coils to be used while retaining a compact structure and small footprint, allowing a transformer including the winding arrangement to power multiple circuits and/or provide redundancy in both high and low current situations. Lastly, when multiple secondary coils are used, series and parallel connections between the secondary coils can be tailored to allow the transformer to operate with the desired power over and large voltage and frequency range.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows an example of a known transformer.

FIG. 2A shows a transformer according to an example embodiment of the present invention.

FIG. 2B shows the transformer core and winding unit of the transformer of FIG. 2A in isolation.

FIG. 3A shows the transformer of FIG. 2A with the upper panel removed.

FIG. 3B shows a plan view of FIG. 3A.

FIG. 3C shows a side view of the transformer of FIG. 2A.

FIG. 3D shows a second side view of the transformer of FIG. 2A.

FIG. 3E shows a bottom view of the transformer of FIG. 2A.

FIG. 3F shows a bottom view of the transformer of FIG. 2A with the lower panel removed.

FIG. 4 shows a winding unit in another example embodiment of the present invention.

FIG. 5 shows a transformer according to an example embodiment of the present invention.

FIG. 6 shows a transformer core according to another example embodiment of the present invention in isolation.

FIG. 7A shows a winding arrangement in an example embodiment of the present invention.

FIG. 7B shows a first section of a coil of an example embodiment of the present invention.

FIG. 7C shows a second section of a coil of an example embodiment of the present invention.

FIG. 7D shows an alternative view of the second section of FIG. 7C.

FIG. 7E shows a coil of an example embodiment of the present invention.

FIG. 7F shows a cross sectional view of the winding arrangement of FIG. 7A.

FIG. 8A shows a winding arrangement in an example embodiment of the present invention.

FIG. 8B shows an alternative view of the winding arrangement of FIG. 8A.

FIG. 9A shows a first section of a secondary coil of an example embodiment of the present invention.

FIG. 9B shows an alternative view of the first section of FIG. 9A.

FIG. 9C shows a second section of a secondary coil of an example embodiment of the present invention.

FIG. 9D shows an alternative view of the second section of FIG. 9C.

FIG. 9E shows two secondary coils of an example embodiment of the present invention.

FIG. 10A shows four secondary coils of an example embodiment of the present invention.

FIG. 10B shows nine secondary coils of an example embodiment of the present invention.

FIG. 10C shows ten secondary coils of an example embodiment of the present invention.

FIG. 11A shows two secondary coils of an example embodiment of the present invention.

FIG. 11B shows two secondary coils of an example embodiment of the present invention.

FIG. 11C shows two secondary coils of an example embodiment of the present invention.

FIG. 12A shows four secondary coils of an example embodiment of the present invention.

FIG. 12B shows nine secondary coils of an example embodiment of the present invention.

FIG. 12C shows ten secondary coils of an example embodiment of the present invention.

FIG. 12D shows an alternative view of the ten secondary coils of FIG. 12C.

FIG. 13 shows a cross sectional view of a winding material in an example embodiment of the present invention.

FIG. 14 is a graph showing the maximum operating power of an electrical transformer according to example embodiments of the present invention.

FIG. 15A shows a transformer according to a second example embodiment of the present invention.

FIG. 15B shows a cutaway view of a transformer according to a second example embodiment of the present invention.

FIG. 15C shows a cutaway view of a transformer according to a second example embodiment of the present invention.

FIG. 16A shows a transformer according to a third example embodiment of the present invention.

FIG. 16B shows a cutaway view of a transformer according to a third example embodiment of the present invention.

### DETAILED DESCRIPTION OF THE EXAMPLE EMBODIMENTS

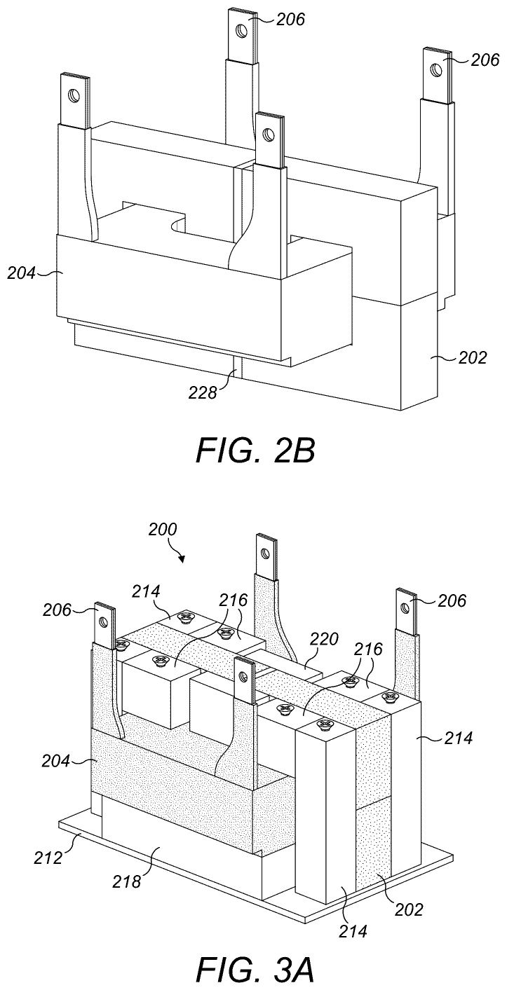

FIG. 2A shows a transformer 200 according to a first example embodiment of the present invention. The transformer 200 includes a transformer core 202 and a winding unit 204 arranged around the transformer core (both shown lightly shaded in FIG. 2A). The winding unit 204 includes a winding. The transformer 200 further includes a mounting arrangement, referred to herein as a housing 208 surrounding the transformer core 202 and the winding unit 204. The housing 208 includes an upper panel 210 and a lower panel 212, and includes a plurality of thermally conductive sections 214, 216, 218, also referred to as thermal conductors, in thermal contact with the winding unit 204 and the transformer core 202, as will be explained in more detail below.

The transformer 200 can be a high-frequency transformer, a high-voltage transformer, a high-power transformer, a high-power, high-frequency transformer, a high-voltage, high-frequency, high-power transformer, or the like. A single-phase shell-type transformer is shown in FIGS. 2A and 2B and throughout this specification; however, example embodiments of the present invention could also be applied in multiphase shell-type transformers and multiphase core-type transformers.

FIG. 2B shows the transformer core 202 and a winding unit 204 in isolation. The transformer core 202 includes a UU type core constructed from four U-shaped cores. Although UU type cores will be used as the main example throughout this description, UI type cores could also be used as an alternative, or in combination with UU type cores. The UU core construction can alternatively be achieved with EI arrangements as well as UI arrangements. Two U-shaped cores are combined to create a closed core. Two closed cores are then combined side by side to construct a core layer. When only U-shaped cores are used, each core layer will include four U-shaped cores, as shown in FIG. 2B. However, more than two core layers could be used in some example embodiments, with multiple core layers stacked together, as shown in FIG. 6 below. Therefore, in general, the number of U-shaped cores used varies in multiples of four, depending on the application. Multiple core layers are typically used at higher power levels. The U-shaped cores are made from a magnetic material such as a ferrite material. An optional thermally conductive plate 228 may also be included in the transformer core 202, as will be explained in more detail below.

The winding unit 204 includes at least one primary coil and one or more secondary coils encased in a potting material. The coils in the winding unit 204 share a common winding axis. The winding unit 204 is arranged around the transformer core 202. Specifically, the winding unit 204 surrounds the central portion (the middle strut) of the transformer core as shown in FIG. 2B. Each coil within the winding unit 204 is therefore wound around the central portion of the transformer core 202. Connection terminals 206 extend out of the potting material that allow an electrical connection to be made with the coils within the winding unit 204. The connection terminals 206 may extend in a direction parallel or substantially parallel to the winding axis of the winding unit 204 (perpendicular or substantially parallel to the plane of the winding unit 204).

A number of different winding arrangements could be used in the winding unit 204. For example, round wire windings, flat wire windings, or litz wire may be used. The windings may be formed from square turns or substantially square turns. The winding unit 204 as a whole, including the potting material, may be a square toroidal (donut) shape, as shown in FIG. 2B. The windings may be known pdqb type windings, as disclosed in UK patent application GB2574481A and international patent application publication WO 2019/234453 A1, which are hereby incorporated by reference in their entirety.

Alternatively, other winding arrangements could be used. More than one set of windings may be used in the winding unit 204, and each set of windings may include a number of different coils, for example, a primary and one or more secondary coils. The windings in the winding unit 204 may be insulated and protected due to the potting material. The potting material may be cast resin, epoxy, or the like. Other transformer-grade potting materials can be used, including silicon. Preferably, the potting material has a temperature class of class H or higher. However, for certain applications Class B or Class F potting materials may also be used.

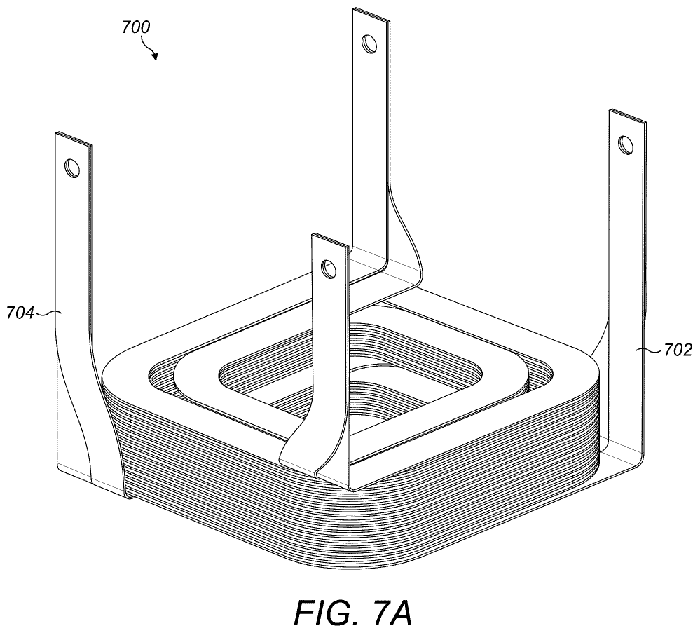

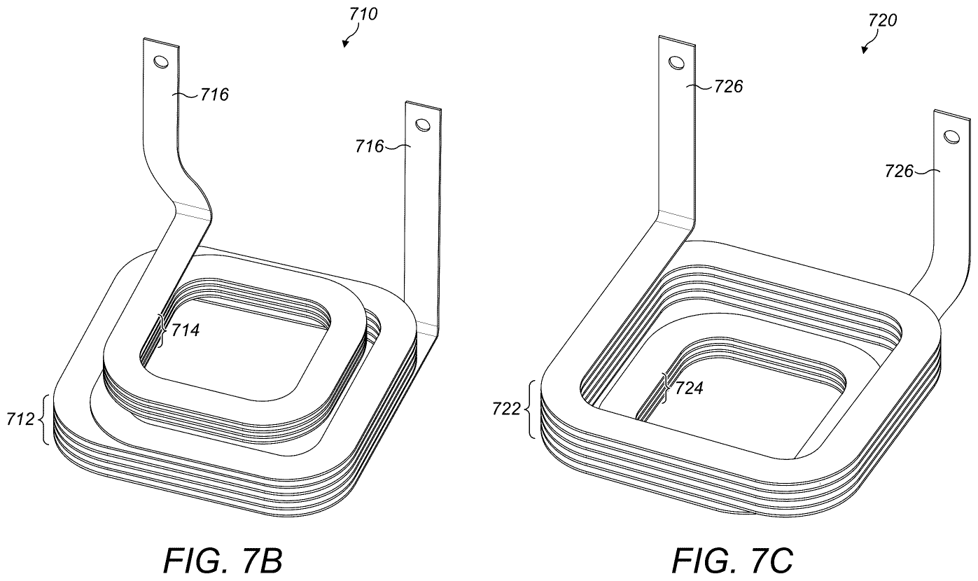

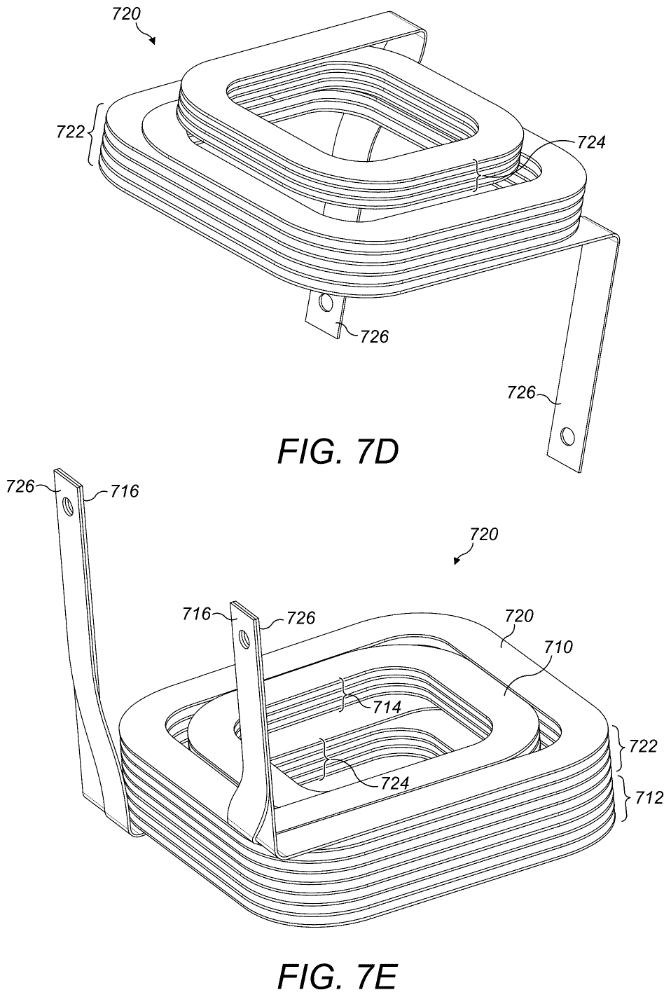

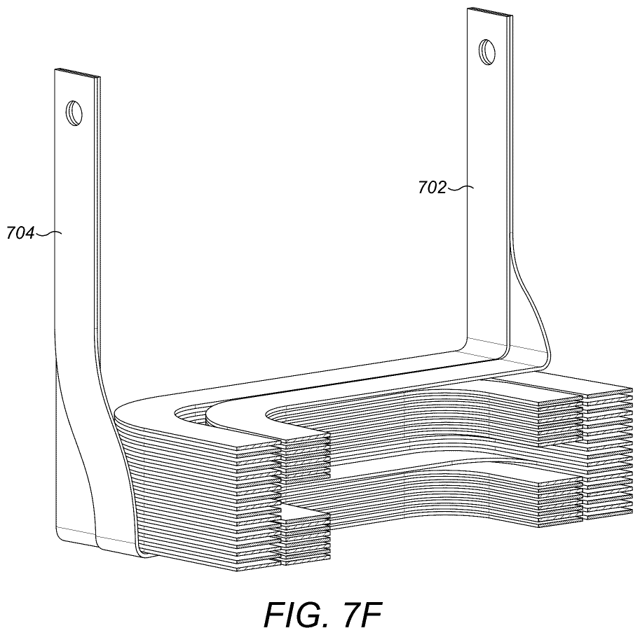

In general, any winding configuration may be used with the transformer core 202 and housing 208. Specific configurations of possible winding arrangements in some example embodiments of the present invention will be discussed in more detail below with respect to FIGS. 7A onwards.

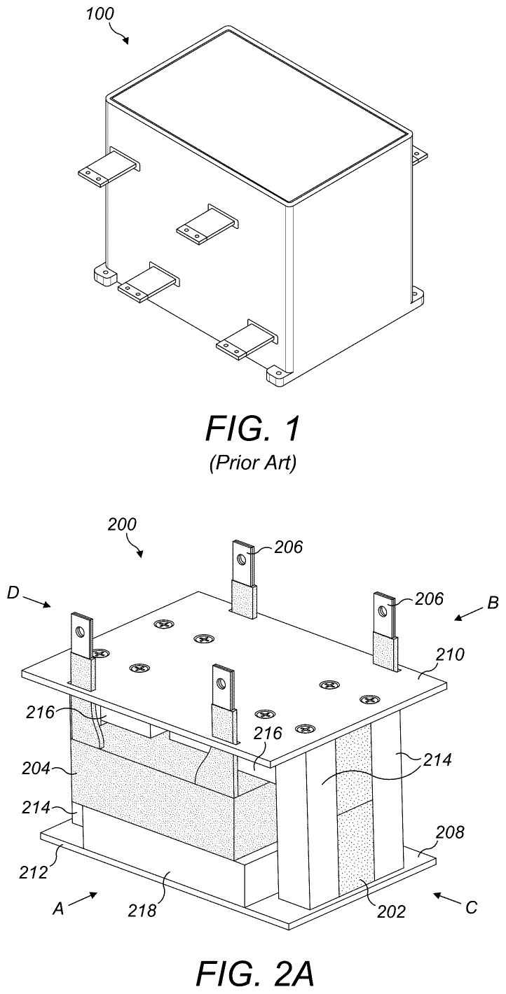

Returning to FIG. 2A, the housing 208 includes one or more open sides such that the winding unit 204 is exposed. In other words, the winding unit 204 is not contained within a fully enclosed housing, unlike the transformer 100 of FIG. 1. Instead, the housing 208 is not fully enclosed in the example embodiments of the present invention, but instead acts as a mounting arrangement for the transformer core 202 and the winding unit 204.

In the present example embodiment, the housing 208 includes two open sides, marked by arrows A, B in FIG. 2A, that expose the winding unit 204. The two open sides A, B are located on opposing sides of the housing 208. The transformer 200 of FIG. 2A is cuboid or substantially cuboid in shape, with the two open sides A, B on opposing faces of the cuboid. Each open side A or B may extend across an entire face of the cuboid-shaped transformer. A typical size of the transformer 200 in a specific example embodiment is about 200 mm by about 140 mm by about 110 mm, withing manufacturing and/or measurement tolerances; however, various other dimensions are possible. In the specific example given, each of the open sides A, B has an area of about 200 mm by about 140 mm, within manufacturing and/or measurement tolerances. However, in some example embodiments, the open sides A, B may extend over only a portion of a given face of the transformer 200. Moreover, in some example embodiments, only one of the sides marked A and B in FIG. 2A may be open so as to expose the winding unit 204 at that side only.

This semi-open construction has a number of benefits. Rather than the entire transformer being encased in a potting material, the hybrid construction where only the winding unit 204 is encased in a potting material results in a reduced weight and reduced manufacturing costs. Moreover, cooling for the winding unit 204 is improved by allowing portions of the winding unit 204 to be exposed to the surrounding air, without having a completely exposed coils (i.e. an unpotted winding unit) and the associated challenges that such a configuration would present (for example, movement of the coils, insulation, and vulnerability to damage). The semi-open construction of example embodiments of the present invention is specifically configured to improve or optimize the trade-off between enhanced cooling and reduced weight versus retaining the structural integrity of the transformer 200.

In more detail, the housing 208 includes an upper panel 210 and a lower panel 212 disposed on opposing sides of the transformer 200. The upper and lower panels 210, 212 both extend in planes normal or approximately normal, within manufacturing and/or measurement tolerances, to a winding axis of the winding unit 204. In other words, the upper panel 210 is located on the top surface of the transformer 200 in FIG. 2A, and the lower panel 210 is located on the bottom surface of the transformer 200 in FIG. 2A. The open sides A, B of the transformer 200 that expose the winding unit 204 may be adjacent to the upper panel 210 and lower panel 212, and may extend between the upper and lower panel 210, 212. For example, in the example embodiment shown in FIG. 2A, the two open sides A, B of the housing 208 extend between upper panel 210 and the lower panel 212 along faces on opposing sides of the transformer 200 that are perpendicular or substantially perpendicular, withing manufacturing and/or measurement tolerances, to the upper and lower panels 210, 212.

The upper panel 210 and lower panel 212 are in contact with the transformer core 202 on the top and bottom sides of the transformer 200. The remaining four sides of the transformer 200 do not include panels in the example embodiment shown in FIG. 2A. Therefore, in the present example embodiment, there are in fact four open sides (four sides not covered by any panels). The winding unit 204 is exposed at the two opposing open sides A, B as mentioned above. The transformer core 202 is exposed at the other two opposing open sides, marked C and D in FIG. 2A, that do not include panels. In other words, in the example embodiment shown in FIG. 2A in which the transformer 200 has a cuboid shape or substantially a cuboid shape, the two opposing sides A, B that expose the winding unit 204, the two opposing sides C, D that expose the transformer core 202, and the upper and lower panels 210, 212 are mutually orthogonal.

In general, of the four open sides A, B, C, D shown in FIG. 2A (i.e., the four sides other than those covered by the upper and lower panels 210, 212), one or both of the sides marked A and B in FIG. 2A may be open so as to expose the winding unit 204, and one or both or neither of the sides marked C and D in FIG. 2A may be open so as the expose the transformer core 202. The example embodiment of FIG. 2A includes all four of these sides open, which provides maximal cooling for the transformer 200, as will be discussed below.

The upper and lower panels 210, 212 may be formed from sheets of material with a high thermal conductivity that will not disrupt the magnetic properties of the transformer 200, for example, a non-magnetic metal could be used, such as aluminum or copper. In some example embodiments, alternative materials may be used for the upper panel 210, such as a non-metallic material. The connection terminals 206 for the primary coil and secondary coil may extend through the upper panel, to allow ease of access.

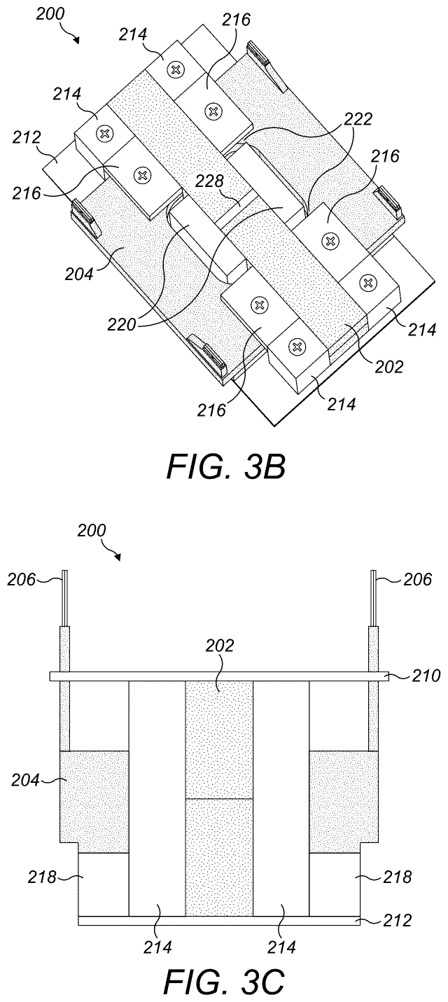

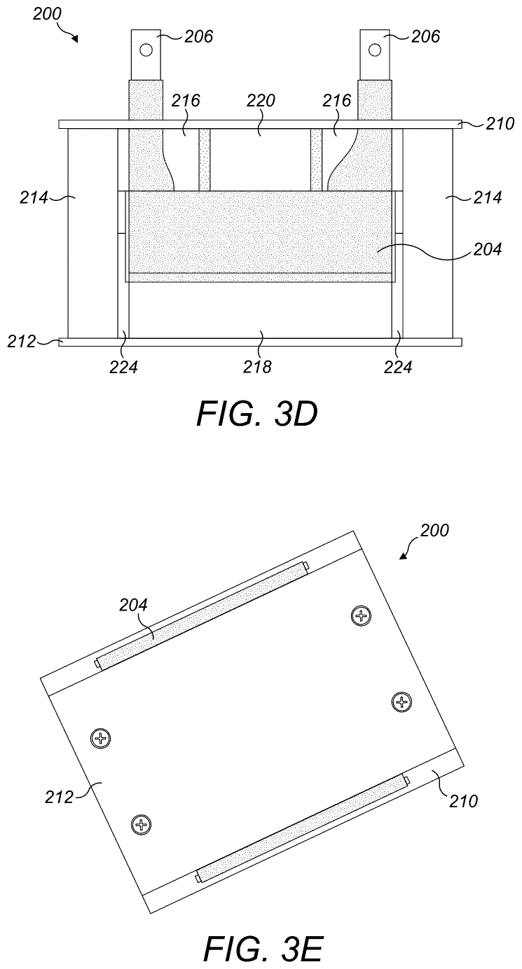

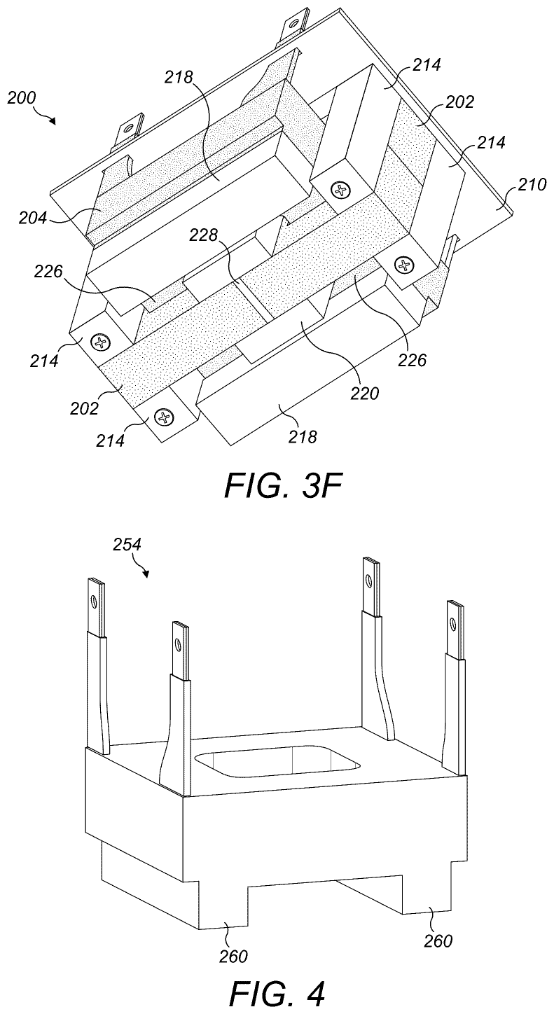

FIGS. 3A to 3F show the housing 208 of the example embodiment of FIG. 2A in more detail. FIG. 3A shows the transformer 200 of FIG. 2A with the upper panel 210 removed. FIG. 3B shows a plan view of FIG. 3A. FIG. 3C shows a side view of the transformer 200 of FIG. 2A. FIG. 3D shows a second side view of the transformer 200 of FIG. 2A. FIG. 3E shows a bottom view of the transformer 200 of FIG. 2A. FIG. 3F shows a bottom view of the transformer 200 of FIG. 2A with the lower panel 212 removed.

As can be seen from FIGS. 2A and 3A to 3F, the transformer 200 includes a plurality of thermally conductive sections 214, 216, 218 in thermal contact with the winding unit 204 and the transformer core 202. The thermally conductive sections 214, 216, 218 may be blocks of thermally conductive material. The plurality of thermally conductive sections 214, 216, 218 include a first set of thermally conductive sections 214, a second set of thermally conductive sections 216, and a third set of thermally conductive sections 218.

The first set of thermally conductive sections 214 extend between the upper panel 210 and the lower panel 212 and are in thermal contact with the upper panel 210 and lower panel 212. Each of the first set of thermally conductive sections 214 is also positioned in thermal contact with the transformer core 202 and the winding unit 204. The first set of thermally conductive sections 214 includes four thermally conductive sections located towards the four corners of the lower panel 212. In other words, two of the first set of thermally conductive sections 214 are located on one side of the winding unit 204, with the transformer core 202 positioned between those two thermally conductive sections 214, and the other two of the thermally conductive sections 214 are located on the opposing side of the winding unit 204, also on either side of the transformer core 202. Each of first set of thermally conductive sections 214 extend in a lengthwise direction parallel or substantially parallel to the winding axis of the winding unit 204, within manufacturing and/or measurement tolerances.

The second set of thermally conductive sections 216 are disposed between the upper panel 210 and the winding unit 204 and are in thermal contact with both the upper panel 210 and the winding unit 204. The second set of thermally conductive sections 216, as best seen in FIG. 3B, are located between the upper surface of the winding unit 204 and the lower surface of the upper panel 210. The second set of thermally conductive sections 216 includes four thermally conductive sections in the present example embodiment, with each being in thermal contact with a respective one of the first set of thermally conductive sections 214.

The third set of thermally conductive sections 218 are disposed between the lower panel 212 and the winding unit 204, and in thermal contact with the lower panel 212 and the winding unit 204. The third set of thermally conductive sections 218 are located between the lower surface of the winding unit 204 and the upper surface of the lower panel 212. The third set of thermally conductive sections 218 includes two thermally conductive sections in the present example embodiment. Each of the third set of thermally conductive sections 218 extends in a lengthwise direction parallel or substantially parallel, within manufacturing and/or measurement tolerances, to the plane of the core layer in the transformer core 202, and perpendicular or substantially perpendicular, within manufacturing and/or measurement tolerances, to the winding axis of the winding unit 204. The third set of thermally conductive sections 218 are best seen in FIG. 3F.

Each of the plurality of thermally conductive sections 214, 216, 218 performs a number of functions.

Firstly, the plurality of thermally conductive sections 214, 216, 218 retain the winding unit 204 within the housing 208, and prevent any movement of movement of the winding unit 204 within the housing 208. All degrees of freedom of the winding (i.e., movement in any direction) is prevented by the plurality of thermally conductive sections 214, 216, 218.

Secondly, the plurality of thermally conductive sections 214, 216, 218 extract heat from the transformer core 202 and the winding unit 204. Each of the plurality of thermally conductive sections 214, 216, 218 is positioned in thermal contact with the transformer core 202 and/or the winding unit 204, depending on the specific example embodiment. In the example embodiment of FIGS. 2A and FIGS. 3A to 3F, each of the first and second sets of thermally conductive sections 214, 216 is in thermal contact with both the transformer core 202 and the winding unit 204, and each of the third set of thermally conductive sections 218 is in thermal contact with the winding unit 204.

Heat from the transformer core 202 and the winding unit 204 is transferred to the plurality of thermally conductive sections 214, 216, 218 through conduction. This heat extracted by the plurality of thermally conductive sections 214, 216, 218 can be removed via various different cooling methods, which will be discussed below. The plurality of thermally conductive sections 214, 216, 218 therefore act as cooling channels within the housing 208.

The plurality of thermally conductive sections 214, 216, 218 provide effective removal of heat from the interior of the transformer 200. This allows the correct temperature levels to be maintained inside the transformer 200, which prevents damage or failure of the transformer 200 occurring.

Some or all of thermally conductive sections 214, 216, 218 may be exposed as well as the winding unit 204, due to the one or more open sides. In the present example embodiment, the two open sides A, B that expose the winding unit 204 also expose a portion of each of the plurality of thermally conductive sections 214, 216, 218. This allows airflow to reach the plurality of thermally conductive sections 214, 216, 218 to aid cooling, as will be discussed in more detail below. The two open sides C, D that expose the transformer core 202 also expose a portion of the first set of thermally conductive sections 214.

The plurality of thermally conductive sections 214, 216, 218 can be made from a material with a high thermal conductivity that will not disrupt the magnetic properties of the transformer 200, for example, a non-magnetic metal could be used, such as aluminum or copper. Each of the plurality of thermally conductive sections 214, 216, 218 may be made out of the same material, or out of various different materials. Blocks of aluminum can be used as the plurality of thermally conductive sections 214, 216, 218, due to the lightweight properties of aluminum.

The housing 208 may be releasably secured together. In particular, some or all of the plurality of thermally conductive sections 214, 216, 218 may be releasably secured to the upper and/or lower panels 210, 212.

In the present example embodiment, each of the first set of thermally conductive sections 214 is releasably secured to the upper panel 210 at a first end of the thermally conductive section 214, 216, 218, and releasably secured to the lower panel at a second end of the thermally conductive section 214, 216, 218. Each of the second set of thermally conductive sections 216 is releasably secured to the upper panel 210. Each of the third set of thermally conductive sections 218 is releasably secured to the lower panel 212.

In the present example embodiment, the plurality of thermally conductive sections 214, 216, 218 are releasably secured using screw attachments. This is shown in FIGS. 3A, 3B, and 3E for the first and second sets of thermally conductive sections 214, 216. The screws are not shown for the third set of thermally conductive sections in the Figures but may be included in some example embodiments. Other releasably securing methods may also be used, such as clips, nails, bolts, or the like.

The releasable connections between the upper and lower panels 210, 212 and the plurality of thermally conductive sections 214, 216, 218 mean that the housing 208 can be easily dismantled and reassembled. This means that the configuration of the housing 208 can be modified after installation, creating a more versatile transformer 200 which may be applied to various different applications.

Optionally, the transformer 200 can include one or more additional thermally conductive sections 220, also referred to as additional thermal conductor, best seen in FIG. 3A. In the present example embodiment, two additional thermally conductive sections 220 are included. The additional thermally conductive sections 220 are disposed against the central portion of the transformer core 202, on either side of the core layer. Each of the additional thermally conductive section 220 extends between the upper panel 210 and the lower panel 212 and is in thermal contact with the upper panel 210 and lower panel 212. The additional thermally conductive sections 220 may also be in thermal contact with the third set of thermally conductive sections 218 in some example embodiments, as shown in FIG. 3F. When the additional thermally conductive sections 220 are included, the winding unit 204 is arranged around both the central portion of the transformer core 202 and the additional thermally conductive sections 220.

The additional thermally conductive sections 220 perform a similar heat extraction function as the plurality of thermally conductive sections 214, 216, 218, and the description above for the plurality of thermally conductive sections 214, 216, 218 applies analogously. Namely, the additional thermally conductive sections 220 can be made from a material with a high thermal conductivity that will not disrupt the magnetic properties of the transformer. The additional thermally conductive sections 220 provide further improvements in the cooling of the transformer 202, as the additional thermally conductive sections 220 can extract heat from the most central portion of the transformer 200.

The additional thermally conductive sections 220 may also be attached to the upper panel and/or the lower panel 210, 212 by a releasably securing method, such as using a screw. Alternatively, the additional thermally conductive sections 220 may be held in position by a gluing or a tight fit arrangement. Moreover, the additional thermally conductive sections 220 may be incorporated into the potting material of the winding unit 204 in some example embodiments, as discussed in more detail below.

The housing 208 may include gaps 222 between the one or more additional thermally conductive sections 220 and the second set of thermally conductive sections 216, as best seen in FIG. 3B. The gaps 222 prevent any eddy current paths being formed due to stray leakage magnetic fields. In other words, the introduction of the gaps 222 in the heat conduction circuit formed by the plurality of thermally conductive sections 214, 216, 218 and the additional thermally conductive sections 220 avoids the formation of conductive paths through the heat conduction circuit. Such conductive paths can result in eddy currents which can cause high temperature rises and energy losses and could lead to shorting due to voltages induced by leakage magnetic fields.

The housing 208 may further include gaps 224 between the ends of each of the third set of thermally conductive sections 218 and the first set of thermally conductive sections 214. The gaps 224 also reduce or prevent eddy currents and shorting, similarly to the gaps 222. Due to the gaps 222 and gaps 224 an electrically conductive path around the perimeter of the transformer 200 through the plurality of thermally conductive sections 214, 216, 218 and the additional thermally conductive sections 220 is advantageously prevented.

In the example embodiment shown in FIGS. 2A to 3F, a winding unit 204 with a square toroidal shape is used (as shown in FIG. 2B) is used. When such a winding unit 204 is used, cavities 226 are present between the third set of thermally conductive sections 218 and the transformer core 202, as best seen in FIG. 3F. If the additional thermally conductive sections 220 are included, the additional thermally conductive sections 220 extend into these cavities 226.

FIG. 4 shows an alternative winding unit 254, for use in another example embodiment of the present invention. The winding unit 254 is the same as the winding unit 204 in FIG. 2B, except that the winding unit 254 includes a pair of protrusions 260 which fill the cavities 226 shown in FIG. 3F. The pair of protrusions 260 engage with the transformer core 202 when the winding unit 254 is arranged around the transformer core, with a portion of the transformer core 220 located between the protrusions 260. In other words, a groove is formed between the protrusions 260, into which the transformer core 202 is seated. The interlocking between the protrusions 260 and the transformer core 202 means that the winding unit 204 is held securely in place arranged around the transformer core 202, preventing any movement of the winding unit 204 within the housing 208.

When the winding unit 254 is fitted into the housing 208, the pair of protrusions 260 extend between the winding unit 254 and the lower panel 212. The pair of protrusions 260 may be formed from the potting material. In other words, the potting material surrounding the coils within the winding unit 254 and the potting material forming the protrusions 260 may be formed as one integral piece (formed as a single unit).

In some example embodiments, the protrusions 260 may themselves be releasably secured to the lower panel 212, in a similar fashion to the plurality of thermally conductive sections 214, 216, 218, for example by screw fixings. The protrusions 260 may include aluminum blocks molded into the potting material, into which a screw or the like can engage to couple the protrusions to the lower panel 212. This can provide a strong mechanical fixing, with all the possible degrees of freedom of movement of the winding unit 254 restricted.

In both example embodiments of the winding unit 204 and 254, the winding unit 204 and 254 may be formed by injection molding, specifically insert molding or overmolding. The coils in the winding unit 204 and 254 are positioned into a mold, such as a Teflon or silicone mold, and then the potting material is cast into the mold to encase the coils, and optionally form the protrusions 260. The mold is then removed to leave the integrally formed winding unit 204 and 254. The mold may be formed of two halves which can be disconnected from each other after the molding process, to release the finished winding unit 204 and 254. Other methods of forming the winding unit 204 and 254 are also possible.

In further example embodiments, when the one or more additional thermally conductive sections 220 are included, the one or more additional thermally conductive sections 220 may be formed integrally with the winding unit 204 and 254. In other words, the one or more additional thermally conductive sections 220 may also be positioned within the mold prior to the introduction of the potting material, such that portions of the one or more additional thermally conductive sections 220 may be incorporated into (encased in) the potting material in the completed winding unit 204 and 254. The additional thermally conductive sections 220 will then be integral with the winding unit 204 and 254.

In the case of the winding unit 204 of FIG. 2B, when the additional thermally conductive sections 220 are integral with the winding unit 204, the central portion of each additional thermally conductive section 220 will be included within the potting material. In the case of the winding unit 254 of FIG. 4, the central portion of each additional thermally conductive section 220 will be included within the potting material, and the bottom portion of each additional thermally conductive section 220 (towards the lower panel 212) will be included in potting material of the protrusions 260.

Molding the winding unit 204 together with the additional thermally conductive section 220 to form a single integral unit means that when the winding unit 204 is arranged around the transformer core 202, the additional thermally conductive sections 220 will be held securely against the central portion of the transformer core 202 by the potting material.

The above-described example embodiments provide a number of advantages. Firstly, the hybrid semi-potted and open construction, where just the winding unit 204 is potted and sides of the housing 208 remain open, means that cooling air can reach the winding unit 204 with ease. However, due to the potting material around the windings, the challenges associated with fully exposed windings, such as movement of the coils, insulation, and vulnerability to damage, are reduced or negated.

Moreover, the reduction in the amount of potting material needed leads to a reduction in manufacturing costs, as well as a reduction in the weight of the transformer 200. For example, a typical dimension of the transformer 200 of the above example embodiments is about 200 mm by about 140 mm by about 110 mm, within manufacturing and/or measurement tolerances. In transformers of this size, approximately 6 kg to approximately 7 kg of potting material can be removed due to the hybrid construction, compared to a comparably sized fully potted or enclosed transformer of the type shown in FIG. 1.

In addition, the above-described construction, particularly the plurality of thermally conductive sections 214, 216, 218 mean that the winding unit 204, 254 is securely held in a fixed position with respect to the transformer core 202 and housing 208, with all degrees of freedom of movement restricted. This ensures improved or optimal performance of the transformer, as well as increasing durability.

Furthermore, the releasable securing of the various components of the housing 208 means that the transformer can be readily dismantled and reassembled, leading to a transformer that is modifiable after construction. For example, the winding unit 204, 254 used in the transformer 200 may be removed and replaced with a different winding unit configuration. Moreover, the transformer 200 can easily be modified between different cooling arrangements, as outlined in more detail below. Therefore, the transformer 200 of the example embodiments described above provides a adaptable yet compact construction.

As well as holding the housing 208, and fixing the winding unit 204 in place, the plurality of thermally conductive sections 214, 216, 218 act as cooling channels, along with additional thermally conductive sections 220, to create a thermal conduction circuit. The thermal conduction circuit allows heat to be removed from the windings and the transformer core 202. The positions of the thermally conductive sections 214, 216, 218 are selected such that they provide the most efficient heat conduction paths from the hottest areas of the transformer 200 during operation.

The transformer 200 can be improved or optimized for water cooling arrangement. For example, the transformer 200 can be cold plate mounted to remove the heat extracted by the plurality of thermally conductive sections 214, 216, 218 and the additional thermally conductive sections 220.

In one example embodiment, the lower panel 212 may be mounted onto a cold plate, so as to be in thermal contact with the cold plate. In another example embodiment, the lower panel 212 may itself be a cold plate. A cold plate may also be referred to as a cooling plate, and is typically water cooled. Heat is able to flow through the plurality of thermally conductive sections 214, 216, 218 and the additional thermally conductive sections 220 into the lower panel 212 to be removed from the transformer 200.

Other cooling methods are possible. For example, alternatively to the cooling plate arrangement described above, or in addition to the cooling plate arrangement, in some example embodiments, one or more of the plurality of thermally conductive sections 214, 216, 218 may include radiating fins. The radiating fins increase the surface area of the plurality of thermally conductive sections 214, 216, 218. These radiating fins may be cooled by forced air cooling or natural air cooling to remove heat from the plurality of thermally conductive sections 214, 216, 218 that has been extracted from the winding unit 204, 254 and/or transformer core 202. The open sides of the housing allow the airflow to reach the plurality of thermally conductive sections 214, 216, 218 in order to cool the radiating fins.

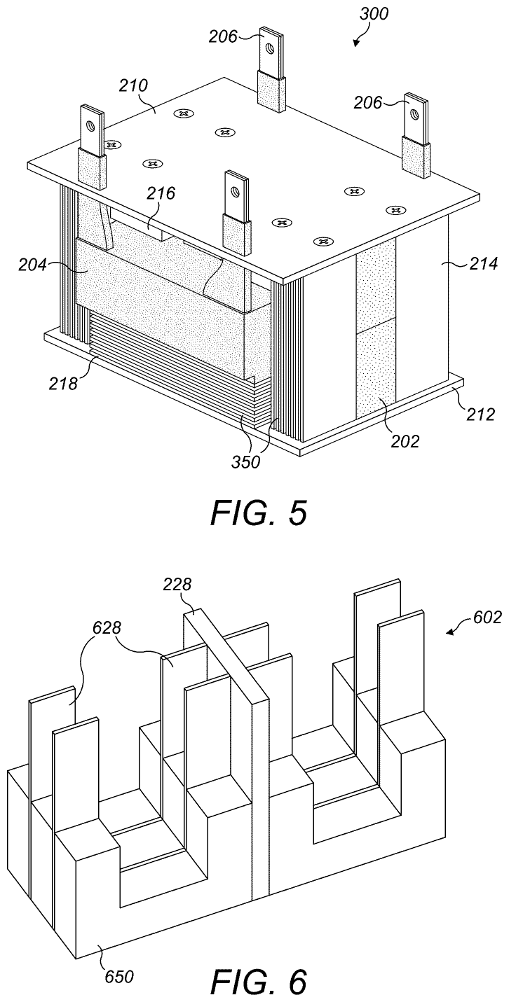

Radiating fins may be included on the outer surfaces of any or all of the plurality of thermally conductive sections 214, 216, 218. FIG. 5 shows one example of such a transformer 300, that includes radiating fins 350 on the first set of thermally conductive sections 214 and the third set of thermally conductive sections 218. The transformer 300 of FIG. 5 is identical to the transformer 200 of FIG. 2A, except for the addition of the radiating fins 350. In other example embodiments, the second set of thermally conductive sections 216 may also include radiating fins. Radiating fins may be located on any outer surface (any surface exposed to the air) of any of the plurality of thermally conductive sections 214, 216, 218.

The releasably secured connection between the components of the housing 208, particularly the plurality of thermally conductive sections 214, 216, 218 and the upper and lower panels 210, 212, means that the transformer 300 can be easily swapped between different cooling configurations, for example, attaching to different cooling plates, or swapping out thermally conductive sections without radiating fins for thermally conductive sections with radiating fins as necessary. In other words, a simple change of the plurality of thermally conductive sections 214, 216, 218 and/or lower panel 212 means that the transformer 300 can be made suitable for various different forced-air cooled, natural-convection cooled or water-cooled, plate-mounted constructions. This modification is easily performed, for example, using the screw fastenings described in FIGS. 2 and 3.

Typically, a cold plate will be used for transformers with a higher power to provide active cooling of the transformer. Water-cooled cold plates can therefore provide a considerable boost in the level of the power that can be derived from the transformer without overheating.

The transformer 200, 300 according to the example embodiments of present invention is therefore compatible with almost all cooling techniques used in the industry for applications over various different power levels. The above-described transformer construction therefore provides a universal high-frequency transformer design that can be adapted to be used in almost all applications with a power rating in the range of about 50 kW to about 100 kW, for example. Of course, the features of the example embodiments described above may also be applied to transformers with different power ratings.

Optionally, some or all of the plurality of thermally conductive sections 214, 216, 218 include at least one outer surface that is colored black. In some example embodiments the entire surface of one or more of the thermally conductive sections 214, 216, 218 may be colored black. This coloring can lead to better heat radiation, and therefore improved cooling, due to the increase in black body radiation. In some example embodiments, the outer surfaces of the upper and lower panels 210, 212 may also be colored black.

Initial tests determined that coloring the thermally conductive sections 214, 216, 218 in a black color allowed the transformer to be used at approximately about 5 kW higher power for the same temperature increase.

Returning to FIGS. 2A to 3F, the transformer core 202 may optionally include a thermally conductive plate 228 within the transformer core 202. Such thermally conductive plates are described in UK patent application publication GB2597670A and international patent application publication WO 2022/023744, which are hereby incorporated by reference in their entirety.

The thermally conductive plate 228 is best seen in FIG. 2B. The thermally conductive plate 228 is disposed between the closed cores in the single core layer of the transformer core 202 of FIG. 2B and extends along the winding axis of the winding unit 204, 254 so as to bisect the core layer. The thermally conductive plate 228 is in contact with the upper and lower panels 210 and 212 at either end of the thermally conductive plate 228 and is also in thermal contact with the additional thermally conductive sections 220 if these are present. The thermally conductive plate 228 transfers heat away from the interior of the transformer core 202 via conduction, which can then be removed via the cooling method discussed above. The thermal conductive plate 228 further improves the cooling of the transformer 200, 300.

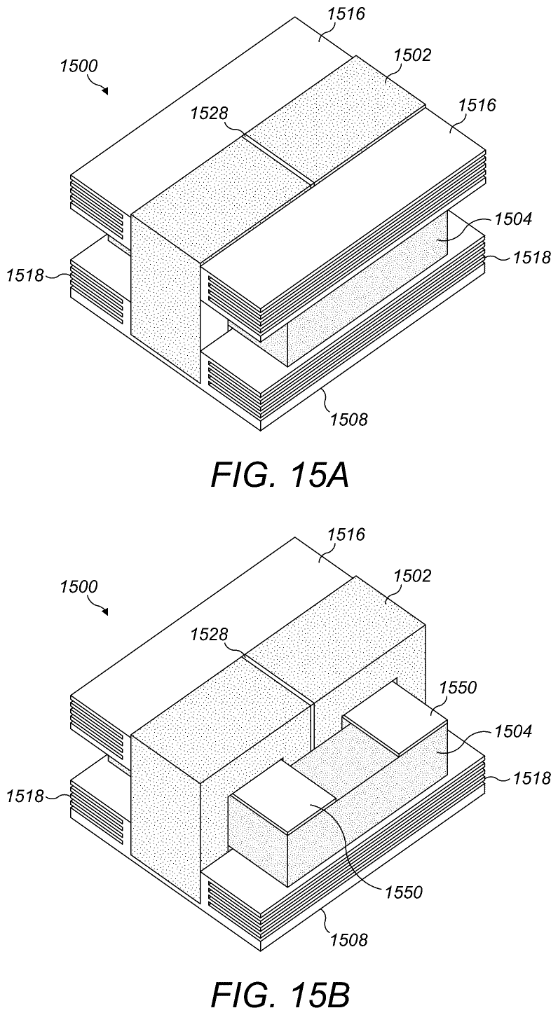

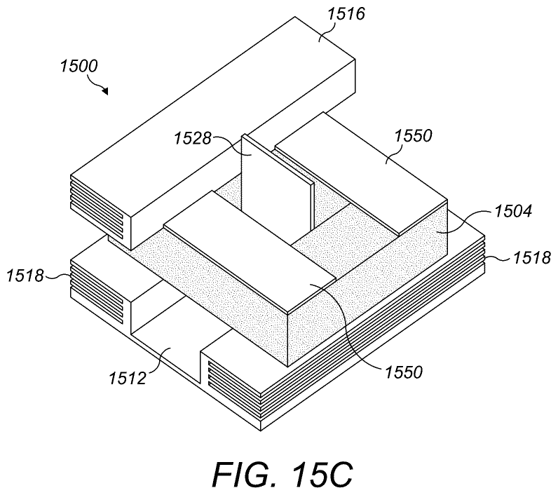

FIG. 15A shows a transformer 1500 according to a second example embodiment of the present invention. The transformer 1500 includes a transformer core 1502 and a winding unit 1504 arranged around the transformer core 1502 (both shown lightly shaded in FIG. 15A). The winding unit 1504 includes windings. The transformer 1500 further includes a housing 1508 surrounding the transformer core 1502 and the winding unit 1504. The housing 1508 includes a plurality of thermally conductive sections 1516, 1518, also referred to as thermal conductors, in thermal contact with the winding unit 1504 and the transformer core 1502. Further, the housing 1508 may optionally include an upper panel 1510 (not shown in FIG. 15A) and a lower panel 1512, which are the same as the upper and lower panels 210, 212 described above for the first example embodiment.

The transformer core 1502 may be the same to that of the first example embodiment, and again may optionally include a thermally conductive plate 1528, analogous to thermally conductive plate 228 of the first example embodiment. The winding unit 1504 is also the same as the winding unit 204 described above for the first example embodiment. Further, if upper and lower panels 1510, 1512 are present, they may be releasably secured to the thermally conductive sections 1516, 1518 using any of the releasably securing methods described in the first example embodiment.

The second example embodiment differs due to the configuration of the plurality of thermally conductive sections 1516, 1518. The plurality of thermally conductive sections 1516, 1518, together with the upper and lower plates 1510, 1512, if present, form the housing 1508 with one or more open sides such that the winding unit 1504 is exposed, analogous to the housing 208 of the first example embodiment. In the second example embodiment shown in FIG. 15A, the transformer 1500 includes four open sides with two of these open sides exposing the winding unit 1504, and the other two exposing the transformer core 1502. However, in the second example embodiment, the plurality of thermally conductive sections 1516, 1518 do not extend between the upper and lower panels 1510, 1512, unlike the first set of thermally conductive sections 214 of the first example embodiment. Instead, the thermally conductive sections 1516, 1518 of the second example embodiment extend along the width of the transformer core 1502, parallel or substantially parallel, within manufacturing and/or measurement tolerances, to the plane of the winding unit 1504, as shown in FIG. 15A.

In the second example embodiment a first pair of thermally conductive sections 1516 are disposed in thermal contact with the upper surface of the winding unit 1504, and the lower surface of the upper panel 1510 (if present), similar to the second set of thermally conductive sections 216 of the first example embodiment. A second pair of thermally conductive sections 1518 are disposed in thermal contact with the lower surface of the winding unit 1504, and the upper surface of the lower panel 1512 (if present), similar to the third set of thermally conductive sections 218 of the first example embodiment. The thermally conductive sections 1516, 1518 perform the same functions as described in the first example embodiment, namely transferring heat away from the winding unit 1504 and transformer core 1502 by acting as cooling channels. The heat transferred by the thermally conductive sections 1516, 1518 may be removed by each of the cooling methods described for the first example embodiment. For example, the thermally conductive sections 1516, 1518 may include radiating fins as described previously (and as shown in FIG. 15A), and/or the lower panel 1512 may be a cold plate to transfer heat out of the thermally conductive sections 1516, 1518.

As well as each of the benefits outlined for the first example embodiment, namely the improved cooling, reduced weight, increased durability, and an adaptable construction, the configuration of the thermally conductive sections 1516, 1518 in the second example embodiment results in a transformer 1500 with a reduced height compared to the first example embodiment. This reduced height is beneficial when seeking to miniaturize the transformer 1500.

The second example embodiment may also include one or more winding cooling plates 1550. The winding cooling plates 1550 are best seen in the cutaway views of FIGS. 15B and 15C. FIG. 15B is the same as FIG. 15A except that one of the nearside thermally conductive sections 1516 has been omitted. FIG. 15C is the same as FIG. 15B except that the U-shaped cores of the transformer core 1502 have also been omitted.

The winding cooling plates 1550 are disposed in thermal contact with the winding unit 1504 and extend in a direction parallel or substantially parallel, within manufacturing and/or measurement tolerances, to the plane of the winding unit 1504 (i.e. a plane normal or approximately normal to the winding axis) and perpendicular or substantially perpendicular, within manufacturing and/or measurement tolerances, to the plane of the transformer core 1502 (i.e. the plane of the core layers). The winding cooling plates 1550 extend through the transformer core 1502. In the second example embodiment, two winding cooling plates 1550 are shown disposed against the upper surface of the winding unit 1504. Further, two winding cooling plates 1550 may be disposed against the lower surface of the winding unit 1504 in some example embodiments (not shown in FIG. 15B or 15C). The winding cooling plates 1550 are located between the thermally conductive sections 1516, 1518 and the winding unit 1504, in thermal contact with both the winding unit 1504 and the thermally conductive sections 1516, 1518. In this way, the winding cooling plates 1550 facilitate heat transfer from the winding unit 1504, particularly the center of the winding unit 1504, and into the thermally conductive sections 1516, 1518 where the heat can be removed, for example via the radiating fins. In other words, the winding cooling plates 1550 extend between two opposing open sides of the transformer 1500, between the pairs of thermally conductive sections 1516, 1518 positioned on opposing sides of the transformer core 1502, to allow transfer of heat away from the center of the transformer 1500. In general, any number of winding unit cooling plates 1550 may be used, with any combination of winding cooling plates 1550 disposed above or below the winding unit 1504.

The winding cooling plates 1550 improve the thermal management and cooling of the transformer 1550, particularly in the reduced height transformer 1500 of the second example embodiment. However, the winding cooling plates 1550 may also be used in combination with any of the other example embodiments herein, such as the first example embodiment of FIGS. 2A to 5. Further, the additional thermally conductive sections 220 and winding unit 204 with protrusions 260 as described in the first example embodiment, may both also be used in the second example embodiment.

FIG. 6 shows another example of a transformer core 602, that may be used in any of the previous example embodiments. The transformer core 602 includes a three core layers stacked together, and therefore includes twelve u-shaped cores 650 in total. The upper six u-shaped cores 650 have been omitted in FIG. 6, to allow the thermally conductive plates to be seen more clearly. The transformer core 602 includes a thermally conductive plate 228 between the closed cores, bisecting the core layers, similar to the thermally conductive plate 228 described above.

The transformer core 602 including multiple core layers may optionally include one or more secondary thermally conductive plates 628 disposed between the core layers, as shown in FIG. 6. The one or more secondary thermally conductive plates 628 are disposed between adjacent U-shaped cores, between the core layers, in a plane orthogonal or substantially orthogonal, within manufacturing and/or measurement tolerances, to the plane of the (primary) thermally conductive plate 228, and parallel or substantially parallel, within manufacturing and/or measurement tolerances, to the axial direction of the windings. The secondary thermally conductive plates 628 are in contact with the upper and lower panels 210 and 212 at either end of the secondary thermally conductive plates 628. The secondary thermally conductive plates 628 further increase the amount of heat extracted from the transformer core 602, due to the increased contact area with the U-shaped cores 650.

The thermally conductive plates 228, 628 are positioned in planes which are parallel or substantially parallel, within manufacturing and/or measurement tolerances, to the magnetic field inside the core, so as to have no effect on the magnetic circuit. The thermally conductive plates 228, 628 can be made from a material with a high thermal conductivity that will not disrupt the magnetic properties of the transformer, such as aluminum. For example, a non-magnetic metal could be used, such as aluminum or copper.

Of course, in general various transformer core constructions may be used, with any number of core layers being included, and different combinations of the thermally conductive plates 228, 628.

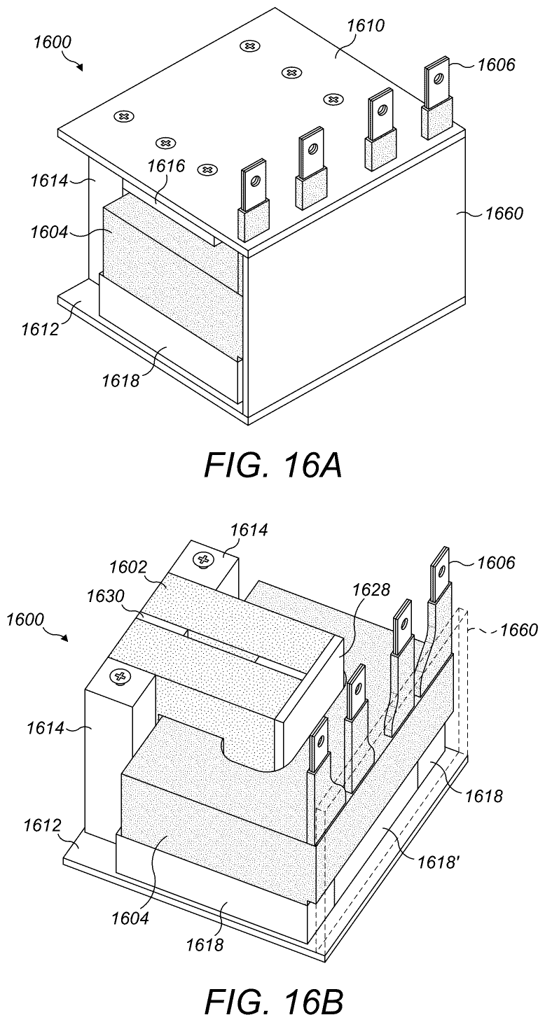

FIG. 16A shows an alternative configuration of a transformer 1600 according to a third example embodiment of the present invention. The transformer 1600 of FIG. 16A is similar to the transformer 200 of the first example embodiment, and includes a transformer core 1602, a winding unit 1604, connection terminals 1606, and a housing 1608 that includes an upper panel 1610, a lower panel 1612, and a plurality of thermally conductive sections 1614, 1616, 1618. Each of these components is analogous to the corresponding components in the first example embodiment, and therefore a repeat description will be omitted. The winding unit 1604 includes windings. The transformer core 1602 of the third example embodiment also includes a thermally conductive plate 1628 within the transformer core 1602, analogous to thermally conductive plate 228 of the first example embodiment, and also secondary thermally conductive plates 1630 analogous to the secondary thermally conductive plates 628 described in relation to FIG. 6 above. FIG. 16B shows a cutaway view of the transformer 1600, with the upper panel 1610 and thermally conductive sections 1616 removed to enable the interior of the transformer 1600 to be seen.

The transformer 1600 of the third example embodiment differs in that each core layer of the transformer core 1602 includes only one closed core (e.g. two combined U-shaped cores). The example embodiment of FIGS. 16A and 16B includes two core layers; however, any number of core layers may be used, as discussed previously. In this way, the third example embodiment can be thought of as a bisected version of the transformer core 202 of the first example embodiment, with one half of each core layer and one half of the plurality of thermally conductive sections 1614, 1616, 1618, also referred to as thermal conductors, removed compared to the first example embodiment. The winding unit is arranged around the remaining half of the transformer core 1602 and the thermally conductive plate 1628 as previously described.

In more detail, the transformer 1600 of the third example embodiment includes a first set of thermally conductive sections 1614 on one side of the transformer 1600, extending between the upper panel 1610 and the lower panel 1612. The transformer 1600 further includes a second set of thermally conductive sections 1616 and a third set of thermally conductive sections 1618 disposed between the winding unit 1604 and the upper panel 1610 or lower panel 1612 respectively. These sets of thermally conductive sections 1614, 1616, 1618 are analogous to those of the first example embodiment and can be referred to as thermal conductors. However, in the third example embodiment of FIGS. 16A and 16B, the third set of thermally conductive sections 1618 further includes an extra thermally conductive section 1618′ that extends along the side of the transformer 1600 opposing the first set of thermally conductive sections 1614. This extra thermally conductive section 1618′ extends normal or approximately normal, within manufacturing and/or measurement tolerances, to the plane of the core layers of the transformer core 1602, perpendicular or approximately perpendicular, within manufacturing and/or measurement tolerances, to both of the other thermally conductive sections 1618 in the third set of thermally conductive sections 1618. In some example embodiments, the second set of thermally conductive section 1616 may also include an analogous extra thermally conductive section 1616′ (hidden from view in FIG. 16A).

The transformer 1600 of the third example embodiment may also include an optional side plate 1660 disposed on the side of the transformer 1600 opposing the first set of thermally conductive sections 1614 (and perpendicular or substantially perpendicular, within manufacturing and/or measurement tolerances, to both the upper panel 1610 and lower panel 1612). Despite the side plate 1660 shown in FIGS. 16A and 16B, the transformer 1600 still includes three open sides, two exposing the winding unit 1604, and one exposing the transformer core 1602 and first set of thermally conductive sections 1614, result in improved cooling.

The connection terminals 1606 for the winding unit 1604 may all be arranged towards the same side of the transformer 1600 in the third example embodiment, specifically the side with the side plate 1660 in the present example embodiment.

As well as the advantages outlined for the first example embodiment if FIGS. 2 to 5 above, the transformer 1600 of the third example embodiment has the advantage of a more compact footprint compared to the transformer 200 of the first example embodiment. Further, the transformer 1600 of the third example embodiment has an increased leakage inductance, which can be beneficial in some applications.

The third example embodiment may be combined with the additional thermally conductive sections 220 and winding unit 1604 with protrusions 260 described in the first example embodiment, as well as the winding cooling plates 1550 of the second example embodiment.

A number of different windings arrangements according to example embodiments of the present invention will now be described. Each of the winding arrangements described below could be used in the winding units 204, 254, 1504, 1604 of any of the example embodiments of the transformers 200, 300, 1500, 1600 described above. Alternatively, the winding arrangements described below could also be used in any other type of electrical transformer.

FIG. 7A shows a winding arrangement 700 according to an example embodiment of the present invention. The winding arrangement is a pdqb type winding but differs from the pdqb type winding arrangements disclosed in UK patent application GB2574481A and international patent application publication WO 2019/234453 A1 in a number of ways. In particular, each coil in the winding arrangement 700 includes first and second sections connected in parallel, as described below.

The winding arrangement 700 includes a primary coil 702 and a secondary coil 704. The primary coil 702 includes a first section 710 and a second section 720. The first section 710 is shown in isolation in FIG. 7B, and the second section 720 is shown in isolation in FIG. 7C.

The first section 710 of the primary coil 702 includes a first set of turns 712 including a first diameter and a second set 714 of turns including a second diameter. The first set of turns 712 and second set of turns 714 are wound around a common winding axis, and each set of turns may include one or more individual turns. The first diameter is larger than the second diameter such that, when viewed along the common winding axis, the first and second set of turns are concentric with the second set of turns 714 located inside the diameter of the first set of turns 712.

The first section 710 is formed from a single integral piece of wire, to form a continuous electrically conductive path. In other words, a final turn of the first set of turns 712 is connected to a first turn of the second set of turns 714, as shown in FIG. 7B. The connection between the first set of turns 712 and the second set of turns 714 may be referred to as a cross-over portion. Connection terminals 716 may be included at each end of the wire of the first section 710 to allow an electrical connection to be made with the first section 710 of the coil.

Similarly, the second section 720 of the primary coil 702 includes a first set of turns 722 including a first diameter and a second set 724 of turns including a second diameter smaller than the first diameter, with each set of turns including one or more individual turns and being arranged concentrically around a common winding axis. The first and second diameters of the second section 720 are the same as those for the first section 710. The first set of turns 722 and the second set of turns 724 of the second section 720 are also formed from a continuous piece of wire. FIG. 7D shows an alternative view of the underside of the second section 720 shown in FIG. 7C, to allow the connection (cross-over portion) between the first set of turns 722 and the second set of turns 724 to be seen more clearly. Connection terminals 726 may be included at each end of the wire of the second section 720 to allow an electrical connection to be made with the second section 720 of the primary coil 702.

The first section 710 and second section 720 of the primary coil 702 are electrically connected in parallel to form the primary coil 702. This electrical connection may be made via connecting or joining the connection terminals 716, 726 of each of the first and second sections 710, 720. In particular, the connection terminal 716 at a first end of the first section 710 and the connection terminal 726 at a first end of the second section 720 can be connected together, and the connection terminal 716 at a second end of the first section 710 and the connection terminal 726 at a second end of the second section 720 can be connected together.

FIG. 7E shows the full primary coil 702 constructed from the combined first and second sections 710, 720. The first and second sections 710, 720 are wound around the same common winding axis. Therefore, the first sets of turns 712 of the first section 710, the second set of turns 714 of the first section 710, the first sets of turns 722 of the second section 720, and the second set of turns 724 of the second section 720 are all arranged around the same common winding axis. Although formed from the first and second sections 710, 720, the combination of the first section 710 and the second section 720 defines a single primary coil 702, as shown in FIG. 7E.

In the primary coil 702, the second set of turns 724 of the second section 720 are positioned within the first set of turns 712 of the first section 710, and the second set of turns 714 of the first section 710 are positioned within the first set of turns 722 of the second section 720, when viewed along the common winding axis. By “positioned within” it is meant that the second set of turns 724 of the second section 720 are inside the first set of turns 712 of the first section 710, with both the second set of turns 724 and the first set of turns 712 located within the same plane extending perpendicularly or substantially perpendicularly, within manufacturing and/or measurement tolerances, to the common winding axis. Similarly, the second set of turns 714 of the first section 710 are positioned within the first set of turns 722 of the second section 720 such that the second set of turns 714 are located inside the first set of turns 722 and both are located within the same plane extending perpendicularly or substantially perpendicularly, within manufacturing and/or measurement tolerances, to the common winding axis.

The first set of turns 712 of the first section 710 and the first set of turns 722 of the second section 720 fully overlap when viewed along the common winding axis, and the second set of turns 714 of the first section 710 and the second set of turns 724 of the second section 720 fully overlap when viewed along the common winding axis. In other words, the first and second sections 710, 720 have the same footprint.

As well as the primary coil 702 described above, the winding arrangement 700 of FIG. 7A includes a single secondary coil 704. In the present example embodiment, the construction of the secondary coil 704 is the same as the primary coil 702. In other words, the secondary coil 704 also includes a first section 710 and a second section 720 connected in parallel and wound together, as described in relation to FIGS. 7B to 7E for the primary coil 702. The winding arrangement 700 shown in FIG. 7A is therefore constructed from two of the coils shown in FIG. 7E, with one acting as the primary coil 702 and one acting as the secondary coil 704. The primary coil 702 and secondary coil 704 are both wound around the same common winding axis. The primary coil 702 and the secondary coil 704 fully overlap when viewed along the common winding axis. In other words, the primary and secondary coils 701, 704 have the same footprint.

The winding arrangement 700, including both the primary and secondary coils 702, 704, is formed by interleaving the turns of the primary coil 702 with the turns of the secondary coil 704. The primary and secondary coils 702, 704 are interleaved such that each turn of the primary coil 702 (each turn of the first and second sets of turns 712, 714, 722, 724 of both the first and second sections 710, 720 of the primary coil 702) is positioned between two turns of the secondary coil 704 when viewed along a direction perpendicular to the common winding axis. Similarly, each turn of the secondary coil 704 is positioned between two turns of the primary coil when viewed along a direction perpendicular to the common winding axis. Put another way, each turn of the secondary coil 704 includes turns of the primary coil 702 located above and below the secondary coil turn.

In other words, along the direction of the common winding axis, the turns in the winding arrangement 700 alternate between the primary coil 702 and the secondary coil 704. Specifically, the turns of the first sets of turns 712, 722 of the primary coil 702 and the turns of the first sets of turns of the secondary coil 704 alternate along the common winding axis, and the turns of the second sets of turns 714, 724 of the primary coil 702 and the turns of the second sets of turns of the secondary coil 704 alternate along the common winding axis.

The interleaving of the primary and secondary coils 702, 704 is shown in FIG. 7F, which is a cross sectional view through the winding arrangement 700 of FIG. 7A. Different hatching patterns are used to distinguish the primary coil 702 and the secondary coil 704 in the plane of the cross section.

Due to the above-described interleaving of the primary and secondary coils 702, 704, sections of the primary and secondary coils 702, 704 carrying currents in the same direction are not disposed directly adjacent to each other. This has the advantageous effect of reducing the losses caused by the proximity effect.

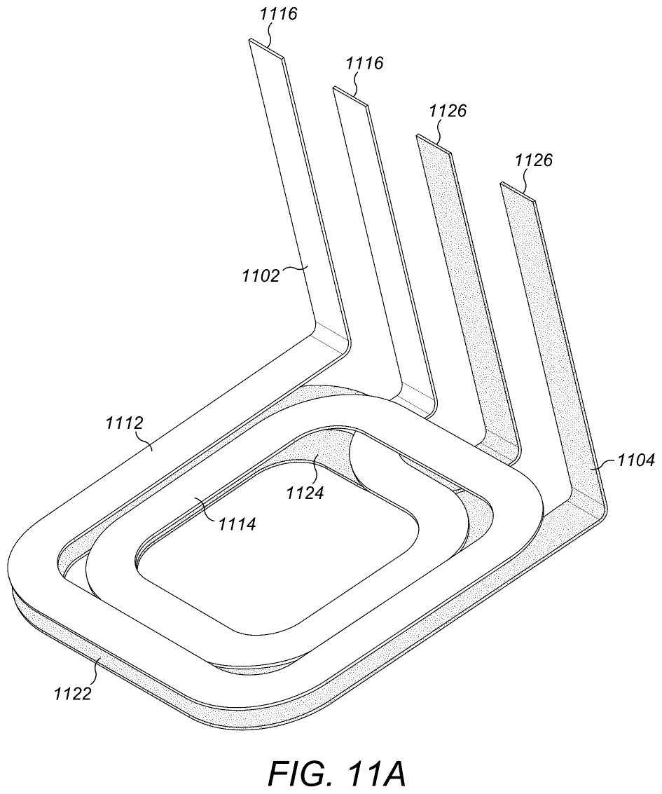

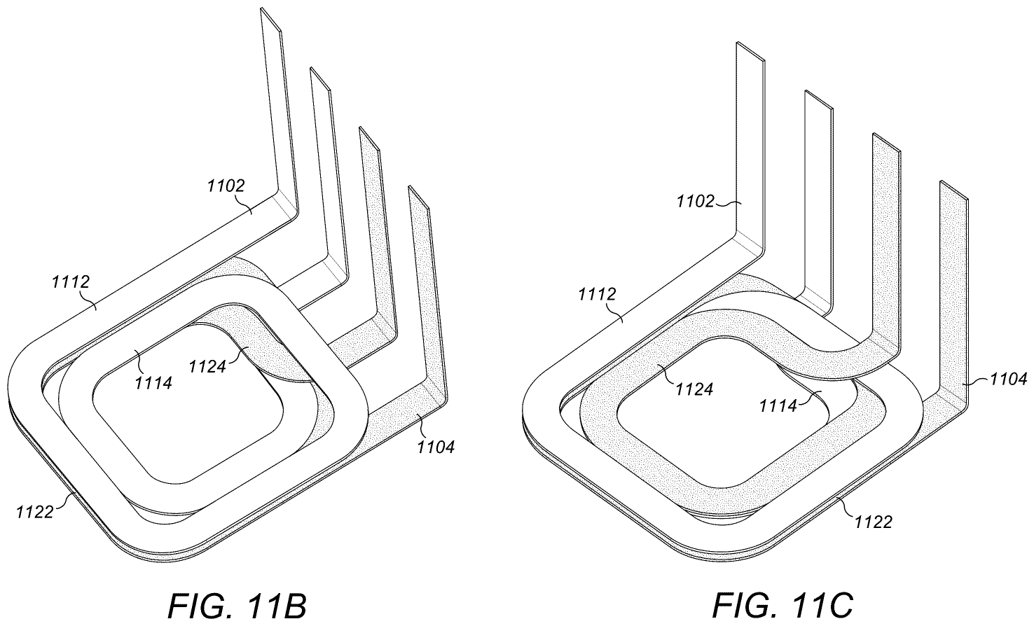

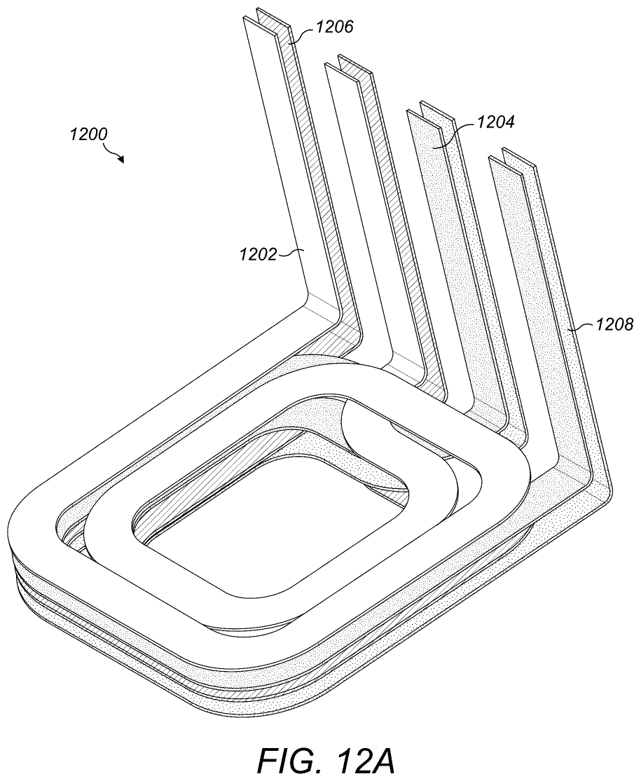

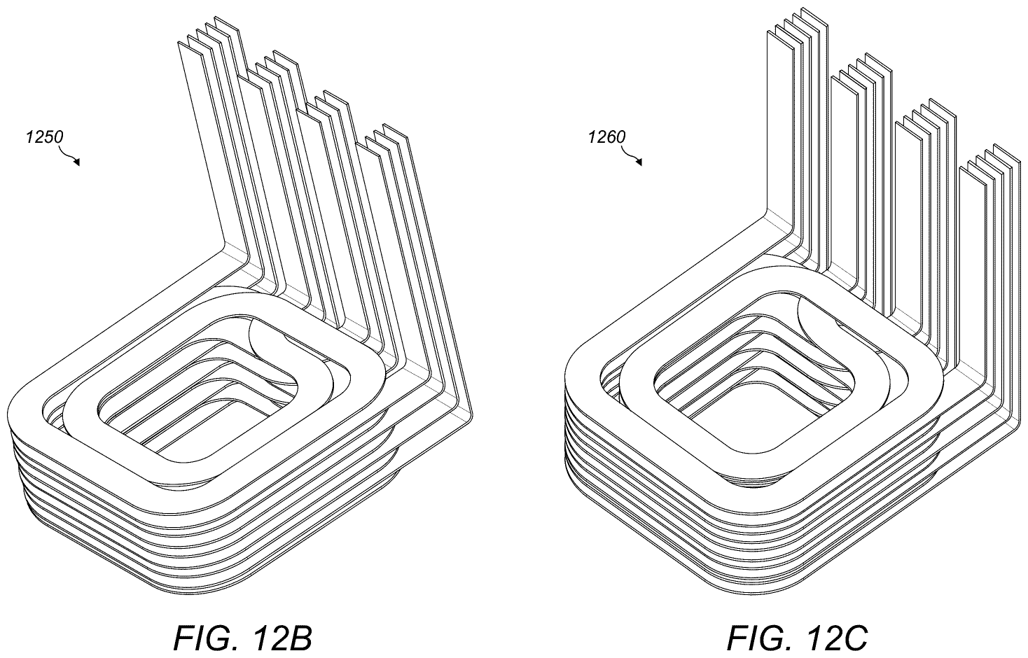

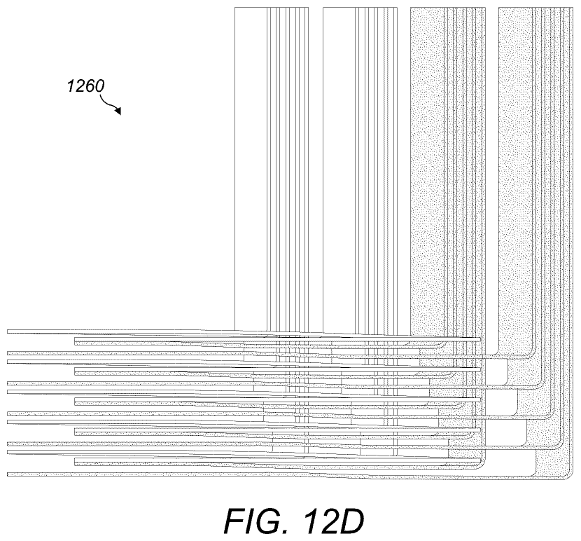

Moreover, the winding arrangement 700 is able to handle high currents due to the primary and secondary coils being formed from the two sections 710, 720 connected in parallel. This is because each section of each coil will only receive half the input current due to the parallel connection of the two sections. In some example embodiments the current level may be as high as about 1200 A. A winding arrangement suitable for low-current applications will be discussed in relation to FIGS. 11A to 12D.

For each of the primary coil 702 and the secondary coil 704 in the winding arrangement 700, the number of turns in the first set of turns 712, 722 of each of the first and second sections 710, 720 of that coil are equal, and the number of turns in the second sets of turns 714, 724 of each of the first and second sections 710, 720 of that coil are equal. In other words, for a given coil 702, 704, the first section 710 and second section 720 both include the same number of turns in their respective first set of turns 712, 722, and the first section 710 and second section 720 both include the same number of turns in their respective second set of turns 714, 724.

Therefore, the first section 710 of each coil 702, 704 is identical to the second section 720 of that coil, other than the bending direction of the connection terminals 716, 726 (best seen from a comparison of FIGS. 7B and 7D). This means that the first section 710 and second section 720 advantageously have the same impedance, due to having the same conductive path length and the same shape. This also necessarily means that the total number of turns in the first section 710 of each coil 702, 704 is equal to the total number of turns in the second section 720 of that coil 702, 704.

In some example embodiments, within each coil section 710, 720 there may be more turns in the first set of turns 712, 722 than in the second set of turns 714, 274. For example, in the present example embodiment, as shown in FIGS. 7B and 7C, each of the first sets of turns 712, 722 include six turns, and each of the second sets of turns 714, 274 include four turns. Alternatively, in each coil section 710, 720, the second set of turns 714, 274 could include more turns than the first set of turns 712, 722 in some example embodiments. In a specific example embodiment, the number of turns in the first and second sets of turns may be equal. For example, in one example embodiment within each coil section 710, 720, the first set of turns 712, 722 may include five turns, and the second set of turns 714, 274 may include five turns. The number of turns may be tailored for the specific application.

Returning to FIG. 7A, in the winding arrangement 700 of the present example embodiment, the primary coil 702 and secondary coil 704 are identical, with the same total number of turns in each coil (the total number of turns here being the combined number of turns in the first set of turns 712 of the first section 710, the second set of turns 714 of the first section 710, the first set of turns 722 of the second section 720, and the second set of turns 724 of the second section 720). In other example embodiments, the primary coil 702 and second coil 704 could include a different number of turns. Typically, the total number of turns in primary coil 702 would be greater than or equal to the total number of turns in the secondary coil 704.

In addition, in the example embodiment of the winding arrangement 700 shown in FIG. 7A, the connection terminals 716, 726 of the primary and secondary coils 702, 704 are also identical. The connection terminals 716, 726 for each section of each coil are bent so as to extend in a direction parallel or substantially parallel, within manufacturing and/or measurement tolerances, to the direction of the common winding axis. The connection terminals 716, 726 at each end of each coil 702, 704 are bent so that they all extend in the same direction away from the sets of turns of the coils 702, 704. For example, in the view of FIG. 7A, each of the connection terminals 716, 726 extend parallel or substantially parallel, within manufacturing and/or measurement tolerances, to the common winding axis in the upward direction in FIG. 7A.

The above-described bending configuration of the connection terminals 716, 726 has the advantage that each point of connection to the primary and secondary coils 702, 704 can be located on the same side of a transformer including the winding arrangement. This is shown in the transformer 200 of FIG. 2A, in which the connection terminals 716, 726 of the winding arrangement 700 may be used as the connection terminals 206 of the transformer 200.

In alternative example embodiments, other bending configurations are possible for the connection terminals 716, 726. For example, the connection terminals 716, 726 could be bent in different directions to each other. For example, in one example embodiment, one or more of the connection terminals 716, 726 may be bent so as to extend along the common winding axis in one direction, and the remaining connection terminals 716, 726 may be bent so as to extend along the common winding axis in the opposing direction. In some example embodiments, the connection terminals 716, 726 could differ for each of primary and secondary coils 702, 704. For example, the direction of extension of the connection terminals 716, 726 for the primary coil 702 may be in a different direction, for example, an opposing direction, to the extension of the connection terminals 716, 726 for the secondary coil 704. In some example embodiments, the connection terminals 716, 726 may extend along a direction other than the direction of the common winding axis. The bending configuration and direction of the connection terminals 716, 726 is chosen to locate the connection points to the coils at the required position when the winding arrangement is used in a transformer 200.

In the winding arrangement 700 of FIG. 7A, the connection terminals 716, 726 of the primary coil 702 and the connection terminals 716, 726 of the secondary coil 704 are located on opposing sides of the winding arrangement. In other words, the connection terminals 716, 726 of the primary coil 702 and the connection terminals 716, 726 of the secondary coil 704 are located on the opposite sides of a plane containing the common winding axis that bisects the winding arrangement. In the view of FIG. 7A, the connection terminals 716, 726 of the primary coil 702 are located on the right hand side of the drawing, and the connection terminals 716, 726 of the secondary coil 704 are located on the left hand side of the drawing. This configuration is advantageous as, when used in a transformer, the connection points of the primary and secondary coils may be more easily identified by the side that they are located at.

Put another way, the winding arrangement 700 of FIG. 7A is formed using two of the coils shown in FIG. 7E, with one acting as the primary coil 702, and one acting as the secondary coil 704. The secondary coil 704 is rotated by 180° about the common winding axis relative to the primary coil 702, before the coils 702, 704 are interleaved, such that the connection terminals 716, 726 of the primary and secondary coils 702, 704 are located on opposing sides of the winding arrangement 700.

In an alternative example embodiment, the connection terminals 716, 726 of the primary and secondary coils 702, 704 may be located on the same side of the winding arrangement 700. In other words, the winding arrangement 700 may be formed using two of the coils 702, 704 shown in FIG. 7E, without any rotation about the common winding axis between the two coils 702, 704. Other rotation angles may also be used, for example 90° and 270°.

In general, the turns of each of the coils 702, 704 in the winding arrangement 700 have a square shape or substantially square shape about the winding axis. However, a rectangular square, a substantially rectangular, a circular shape, a substantially circular, or various other shapes may also be used.

Each set of turns of each coil 702, 704 is arranged (wound) helically around the common winding axis. In other words, each coil 702, 704 is formed from a first helically wound first section 710 connected in parallel with a second helically wound second section 720.

When the winding arrangement 700 of FIG. 7A is used in winding units, such as winding units 204, 254 mentioned above in FIGS. 2 to 6, each of the primary coil 702 and secondary coil 704 may be encased in potting material.

The winding arrangement of the example embodiments of the present invention may also be used in applications with multiple secondary coils.

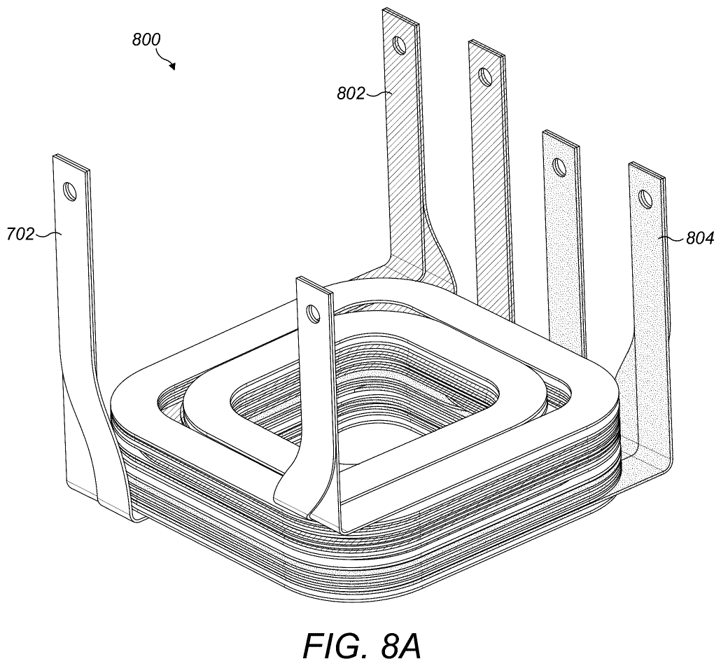

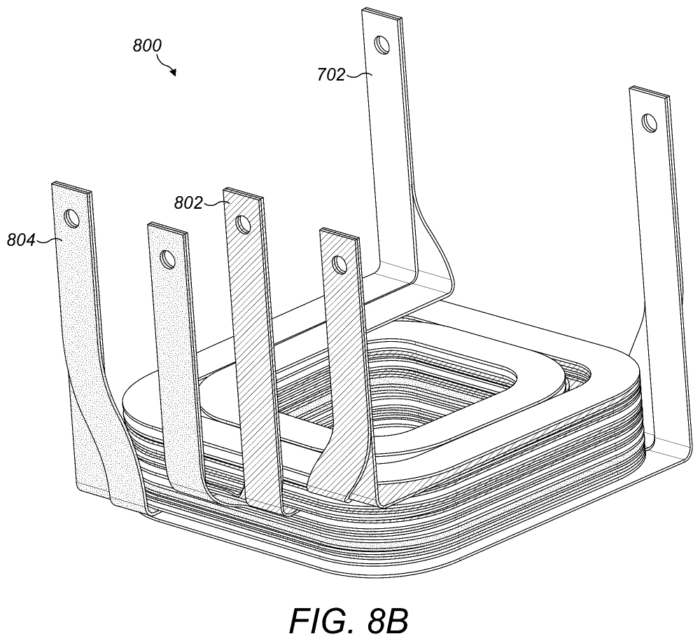

FIGS. 8A and 8B show front and rear perspective views of a winding arrangement 800 in an example embodiment of the present invention including two secondary coils. The winding arrangement 800 includes a primary coil 702 which is the same as the primary coil 702 described in relation to FIGS. 7A to 7F above, and shown in FIG. 7E. The winding arrangement further includes a first secondary coil 802 and an additional secondary coil 804, shown with different shading patterns in FIGS. 8A and 8B.

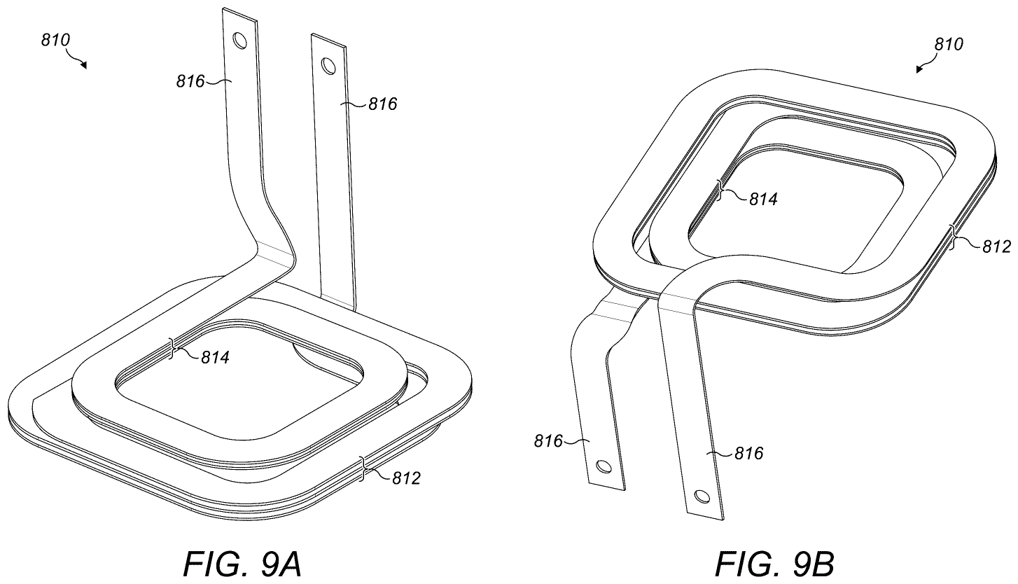

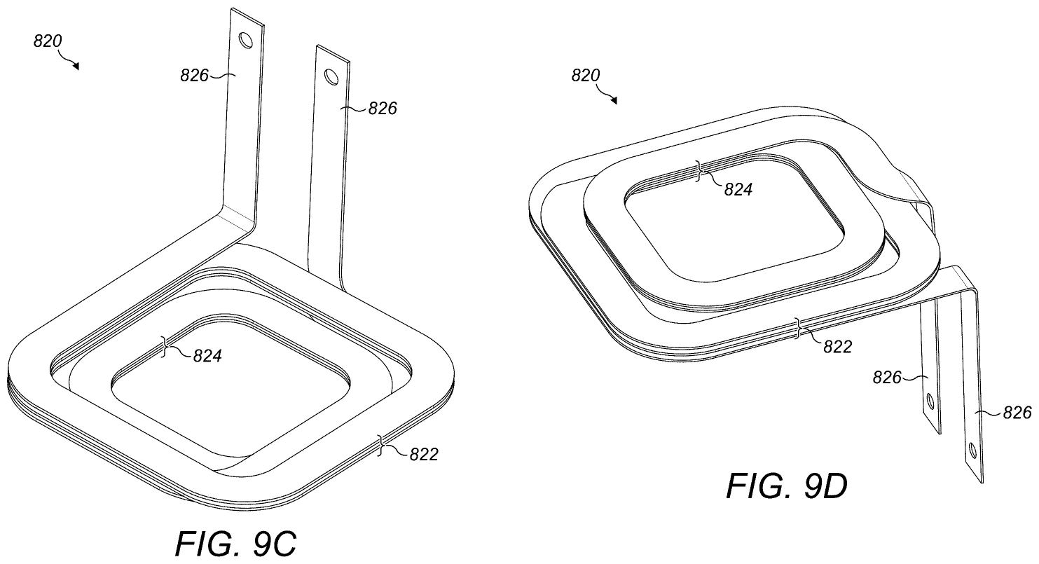

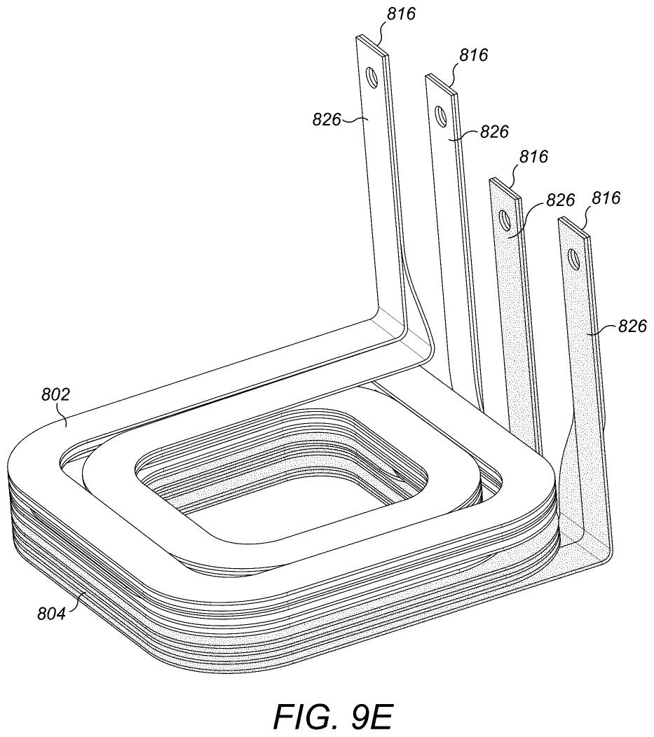

Each of the secondary coils 802, 804 include a first section 810 and a second section 820 connected in parallel and wound together around a common winding axis, in a similar manner to the primary coil 702. FIG. 9A shows a first section 810 of either of the secondary coils, and FIG. 9B shows an alternative (bottom) view of the first section 810 of FIG. 9A. FIG. 9C shows a second section 820 of either of the secondary coils, and FIG. 9D shows an alternative (bottom) view of the second section 820 of FIG. 9C.

The first section 810 of the secondary coils 802, 804 includes a first of turns 812 including a first diameter and a second set 814 of turns including a second diameter smaller than the first diameter, and the second section 820 of the secondary coils 802, 804 includes a first of turns 822 including a first diameter and a second set 824 of turns including a second diameter smaller than the first diameter.

A first section 810 as shown in FIGS. 9A and 9B, and a second section 820 as shown in FIGS. 9C and 9D combine to form each secondary coil 802, 804 (the secondary coil 802 and the additional secondary coil 804). FIG. 9E shows the secondary coil 802 and the additional secondary coil 804 formed from the first and second sections 810, 820 in isolation. Different shading patterns are used for each secondary coil in FIG. 9E. To form each secondary coil 802, 804, the first section 810 and second section 820 of each secondary coil 802, 804 are electrically connected in parallel and are wound around the common winding axis, with the second set of turns 824 of the second section 820 positioned within the first set of turns 812 of the first section 810, and the second set of turns 814 of the first section 810 positioned within the first set of turns 822 of the second section 820, when viewed along the common winding axis.

In other words, the first section 810 and a second section 820 of the secondary coils 802, 804 are analogous to the first and second sections 710, 720 described above. The other features described above for the primary coil 702 apply analogously to the secondary coil 802 and additional secondary coil 804, and will therefore not be repeated here.

As shown in FIG. 9E, the secondary coils 802, 804 stack together, with both being arranged around the same common winding axis. The secondary coils 802, 804 are stacked such that the secondary coil 802 and the additional secondary coil 804 fully overlap when viewed along the common winding axis (i.e. have the same footprint). The stacking of the secondary coils in beneficial for reducing the overall size of the winding arrangement 800.

The connection terminals 816, 826 of the secondary coils are bent so as to extend in a direction parallel or substantially parallel, within manufacturing and/or measurement tolerances, to the direction of the common winding axis, in this case in the same direction as the connection terminals 716, 726 of the primary coil 702 when the secondary coils 802, 804 are combined with the primary coil 702 (as shown in FIGS. 8A and 8B). When the winding arrangement 800 is fully constructed, the connection terminals 816, 826 of the secondary coils 802, 804 are located on opposing sides of the winding arrangement to the connection terminals 716, 726 of the primary coil 702, similarly to the example embodiment shown in FIG. 7A. Moreover, the connection terminals 816, 826 of the secondary coil 802 are arranged adjacent to each other, and the connection terminals 816, 826 of the additional secondary coil 804 are also arranged adjacent to each other. This positioning of the connection terminals makes it easier to identify which connection terminals 816, 826 belong to which secondary coil.

To form the complete winding arrangement 800 shown in FIGS. 8A and 8B, the turns of the primary coil 702 (shown in FIG. 7E) are interleaved with the turns of the secondary coil 802 and additional secondary coil 804 (shown in FIG. 9E).

In the present example embodiment, the primary coil 702 is interleaved with the secondary coils 802, 804 such that each turn of the secondary coil 802 is disposed between two turns of the primary coil 702 and each turn of the additional secondary coil 804 is disposed between two turns of the primary coil 702, when viewed along a direction perpendicular to the common winding axis. Therefore, each turn of each secondary coil 802, 804 includes turns of the primary coil 702 located above and below the secondary coil turn. Once interleaved, each of the primary coil, secondary coil 802, and additional secondary coil 804 fully overlap when viewed along the common winding axis.

In the present example embodiment, the secondary coils 802 and 804 are stacked one on top of the other. This means that the secondary coil 802 interleaves with the primary coil 702 in a first portion of the primary coil 702 (the upper portion of the primary coil 702 in FIGS. 8A and 8B), and the additional secondary coil 804 interleaves with the primary coil 702 in a second portion of the primary coil 702 (the lower portion of the primary coil 702 in FIGS. 8A and 8B). Therefore, the turns of the primary coil 702 and the turns of the secondary coil 802 alternate along a first portion of the common winding axis, and the turns of the primary coil 702 and the turns of the additional secondary coil 804 alternate along a second portion of the common winding axis.

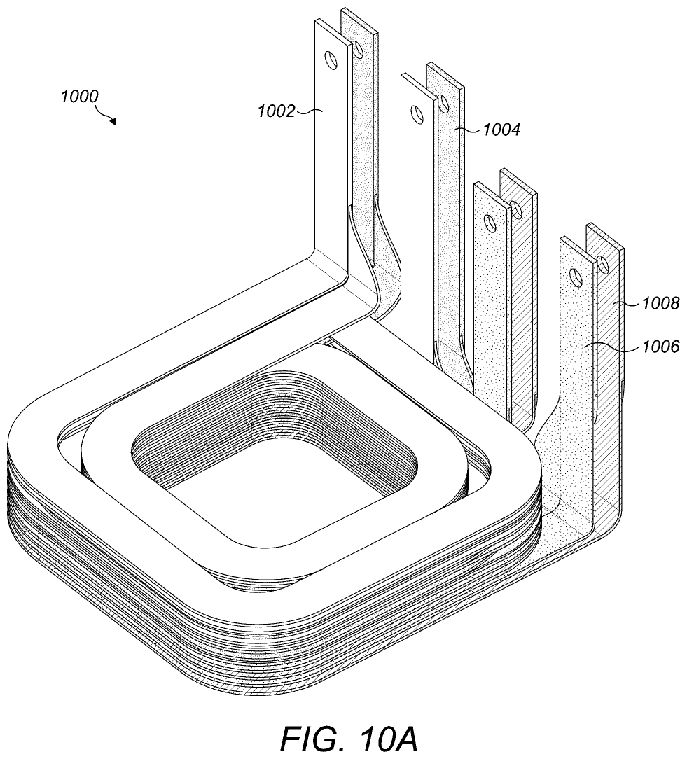

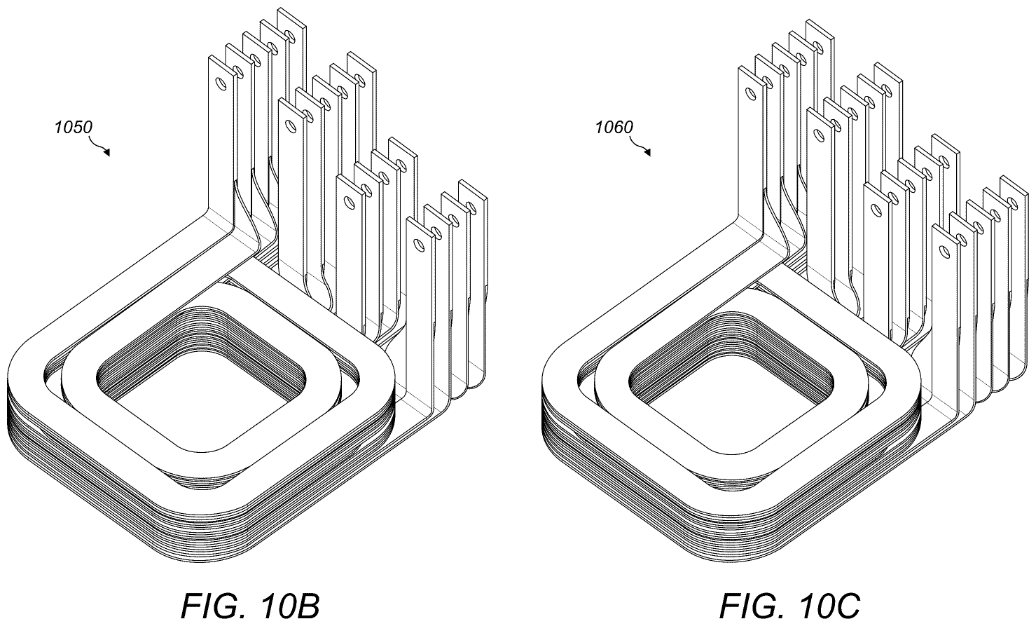

In an alternative example embodiment, the secondary coil 802 and additional secondary coil 804 could interleave with each other as well as the primary coil 702. This will be described in more detail in relation to FIG. 10A.

The interleaving of the primary coil 702 with the secondary coils 802, 804 again reduces the proximity effect by ensuring conductors carrying like currents are not positioned against each other.

Moreover, similarly to the primary coil, each secondary coil is formed by two coil sections connected in parallel. In other words, FIG. 9E shows two secondary coils 802, 804 formed from four coil sections. The use of the parallel coil sections in the primary and secondary coils results in a winding arrangement 800 that is able to handle higher currents.

In further example embodiments, more than two secondary coils may be used. In other words, the winding arrangement may include more than one additional secondary coil. FIG. 10A shows an example embodiment including four secondary coils: secondary coil 1002, and additional secondary coils 1004, 1006, 1008. Different shading patterns are used for each secondary coil in FIG. 10A.

The secondary coils 1002, 1004, 1006, 1008 of FIG. 10A each include the same structure as the secondary coils 802, 804 described above, and a description will therefore not be repeated here. Again, due to the shape and configurations of the secondary coils, the coils neatly stack together, resulting in a more compact winding arrangement.

However, the example embodiment of FIG. 10A differs in that the secondary windings 1002, 1004, 1006, 1008 are interleaved with each other. Specifically, the secondary coils 1002 and first additional secondary coil 1004 interleave with each other, and the second additional secondary coil 1006 and third additional secondary coil 1008 interleave with each other. In general, some or all of the secondary windings may be interleaved with each other. Each pair of secondary windings may be fully interleaved with each other, or only partially interleaved with each other, such that only some of the turns of each secondary coil interleave.

The secondary coil arrangement 1000 of FIG. 10A is then interleaved with the primary coil 702 of FIG. 7E, to form the full winding arrangement. The interleaving is such that each turn of each secondary coil 1002, 1004, 1006, 1008 is positioned between two turns of the primary coil 702, when viewed along a direction perpendicular to the common winding axis, to reduce the proximity effect.

Of course, other numbers of secondary coils may be used. In general, up to twenty secondary coils, including, for example, up to ten secondary coils, may be used. FIG. 10B shows a secondary coil arrangement 1050 including nine secondary coils (one secondary coil and eight additional secondary coils). Similarly, FIG. 10C shows a secondary coil arrangement 1060 including ten secondary coils (one secondary coil and nine additional secondary coils). In other specific example embodiments, three, five, six, seven, or eight secondary coils may be used.

The shape of the primary and secondary coils in the above-mentioned example embodiments provides flexibility to accommodate multiple secondary coils within the same footprint and volume. The coils of the winding arrangement stack around the common winding axis to provide a very compact arrangement, while also preventing proximity effect losses.

Including multiple secondary coils in the winding arrangement provides a number of benefits, including the ability to power multiple circuits, as well as providing redundancy.

In general, when multiple secondary coils are used, the number of turns in the primary coil 702 is greater than or equal to the combined total number of turns in the secondary coils (the secondary coil and the one or more additional secondary coils). For example, when using a primary coil 702 with ten turns in each coil section (for example, five turns in the first set of turns of each coil section, and five turns in the second set of turns in each coil section), a single secondary coil with up to ten turns in each coil section may be used, or two secondary coils with up to five turns in each coil section each may be used, or five secondary coils with two turns in each coil section each may be used. It is also possible, however, for the primary coil to include fewer turns than the combined total number of turns in the secondary coils in some example embodiments.

Each of the above-described example embodiments uses secondary coils with two sections connected in parallel, for higher current applications. FIGS. 11A to 12D show examples of secondary coil arrangements including a plurality of secondary coils suitable for low-current applications, which do not include two sections connected in parallel in the secondary coils.

FIG. 11A shows a secondary coil arrangement for use in an example embodiment of the invention that includes two secondary coils 1102, 1104. Different shading patterns are used for each secondary coil in FIG. 11A. Each of the secondary coils 1102, 1104 includes a first set of turns 1112, 1122 including a first diameter and a second set of turns 1114, 1124 including a second diameter concentric with the first set of turns 1112, 1122. The first and second diameter are the same as the first and second diameters for the primary coil 702 described above. Each secondary coil also includes a pair of connection terminals 1116, 1126 at either end of the coil.

Put another way, each secondary coil 1102, 1104 in FIG. 11A can be formed from one of the coil sections 810, 820 shown in FIGS. 9A to 9D, but without a connection in parallel to a second coil section. The description relating to the coil sections 810, 820 therefore applies analogously here.

In FIGS. 11A to 12D only one turn is shown in each set of turns; however, in general each set of turns of each secondary coil 1102, 1004 may include more than one turn.

The two secondary coils 1102, 1004 are both wound around a common winding axis. The secondary coils 1102 and 1104 are stacked such that the secondary coils 1102, 1104 fully overlap when viewed along the common winding axis.

The secondary coils 1102, 1104 of FIG. 11A (and FIGS. 11B to 12D discussed below) are combined with the primary coil 702 shown in FIG. 7E including two parallel primary coil sections 710, 720, to form a complete winding arrangement. Again, the primary coil 702 and secondary coils 1102, 1104 are both wound around the same common winding axis and are combined by interleaving, with the turns of the primary coil 702 interleaved with the turns of the plurality of secondary coils 1102, 1104. The primary coil 702 is interleaved with the secondary coils 1102, 1104 such that each turn of the secondary coils is disposed between two turns of the primary coil when viewed along a direction perpendicular to the common winding axis. The above-described interleaving prevents losses due to the proximity effect.

FIGS. 11B and 11C show two different possible arrangements for stacking the secondary coils 1102, 1104. In FIGS. 11B and 11C the secondary coils 1102, 1104 are crossed over each other at different locations, rather than being stacked one on top of the other as shown in FIG. 11A without any crossing. In FIG. 11C, the secondary coils are arranged with the second set of turns 1124 of second secondary coil 1104 positioned within the first set of turns 1112 of the first secondary coil 1102, and the second set of turns 1114 of the first secondary coil 1102 are positioned within the first set of turns 1122 of the second secondary coil 1104, when viewed along the common winding axis. In other words, the secondary coils 1102, 1104 may also be partially or fully interleaved with each other, analogously to as described for FIG. 10A. FIG. 11C shows the secondary coils 1102, 1104 interleaved in the case where only one turn is included in each set of turns.

As before, more than two secondary coils may be used. Preferably up to twenty secondary coils, including, for example, up to ten secondary coils, may be used. FIG. 12A shows a secondary coil arrangement 1200 including four secondary coils 1202, 1204, 1206, 1208. Different shading patterns are used for each secondary coil in FIG. 12A. FIG. 12B shows a secondary coil arrangement 1250 including nine secondary coils. FIG. 12C shows a secondary coil arrangement 1260 including ten secondary coils. In other specific example embodiments, three, five, six, seven, or eight secondary coils may be used.

Regardless of the number of secondary coils, due to the construction of the secondary coils they can be neatly stacked together, to form a more compact winding arrangement. The stacking arrangement 1260 in one example embodiment of the present invention including ten secondary coils (the example embodiment of FIG. 12C) is shown in FIG. 12D. Half of the secondary coils are shaded in FIG. 12D, to help show the stacking arrangement. The secondary coils in FIG. 12D are stacked one on top of the other. The secondary coils are then interleaved with the primary coil 702 as described above, with each portion of each secondary coil being positioned between two turns of the primary coil 702, when viewed along a direction perpendicular to the common winding axis, to reduce the proximity effect.

As in the previous example embodiments, the number of turns in the primary coil may be greater than or equal to the combined total number of turns in the plurality of secondary coils.

In general, various numbers of turns and various numbers of secondary coils may be used. In a specific example embodiment, the secondary coil arrangement 1260 shown in FIGS. 12C and 12D, with ten secondary coils each including a single turn in each of the first and second sets of turns, may be combined with the primary coil 702 of FIG. 7E including ten turns in each coil section 710, 720.

The number of turns shown in the drawings and given as examples in the description above are for exemplary purposes only. In general, in each example embodiment, various different numbers of turns may be used in each coil.

In some example embodiments, the high current secondary coils of FIGS. 8A to 10B including two coil sections connected in parallel could be used within the same winding arrangement as the low-current secondary coils of FIGS. 11A to 12D.

Any of the above-described winding arrangements may be used with the hybrid construction transformer described in relation to FIGS. 2 to 6.

Moreover, the above-described winding arrangements may be used in combination with the cooling plate arrangement described in UK patent application publication GB2597470A and international patent application publication WO 2022/018436 A1, which are hereby incorporated by reference in their entirety.

The winding arrangements of each of the example embodiments described above are formed from flat wire. However, in some example embodiments other types of wire may also be used, such as round wire windings or the like.

The wire used in the winding arrangements of each of the example embodiments may be formed from various electrically conductive materials, such as copper or the like. However, in an example embodiment of the present invention, the wire used in the winding arrangement is formed from aluminum, as outlined below.

Traditionally, copper litz wires and copper foils are used in high frequency transformers. Known pdqb-type windings (e.g., the pdqb-type windings disclosed in UK patent application publication GB2574481A and international patent application publication WO 2019/234453 A1) made it possible to use flat copper conductors in high-power, high-frequency transformers. In the example embodiment of the present invention, aluminum wires, for example, aluminum flat wires, are used. Aluminum has not previously been used as a conductor in the windings of high-frequency, high-power transformers.

The use of aluminum as the conductive material in the windings includes a number of benefits, particularly in larger high-frequency transformers, which are becoming more prevalent due to new applications such as use in electric vehicles. Firstly, aluminum has a lower density than traditional conductors such as cooper, and therefore leads to weight savings. Moreover, aluminum is cheaper than traditional conductors such as copper, leading to a lower manufacturing cost.

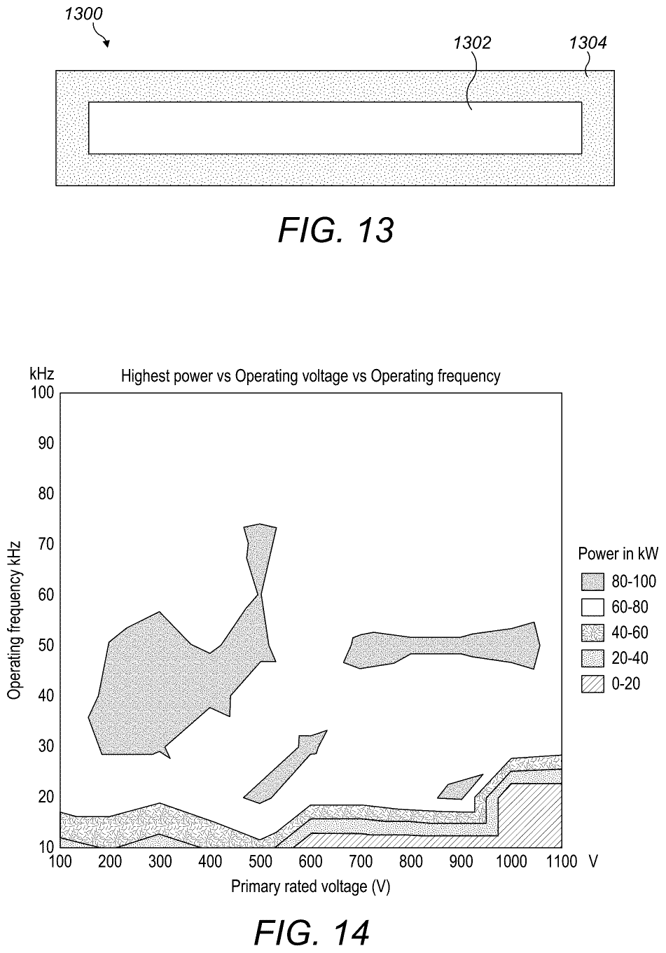

Secondly, carefully selected design parameters can be used with the aluminum windings to provide further benefits. The size of the thickness of the wire conductor is selected to be thicker than twice the skin depth of aluminum. This slight oversizing of the aluminum conductor means that there is an unused area within the center of the aluminum conductor (unused in the sense that it contains a very low or zero current density). FIG. 13 shows a cross section through an aluminum flat wire conductor 1300, with such a central area 1302 with a low or zero current density shown in FIG. 13. The majority of the current carried by the aluminum flat wire conductor 1300 is located within the outer area 1304.

Therefore, a central volume with a very low or zero current density runs along the entire length of the aluminum conductor. This central volume acts as a cooling channel running through the aluminum conductor itself, to allow heat generated within the aluminum conductor to travel along and eventually out of the aluminum conductor. In other words, the size of the aluminum conductor is chosen to make a positive use of the skin depth and proximity effect in the aluminum conductor.

In a particular example embodiment, the flat wire includes a width of between about 10 mm and about 15 mm, within manufacturing and/or measurement tolerances, and a thickness of between about 0.8 mm and about 1.2 mm, within manufacturing and/or measurement tolerances. For example, the thickness of the flat wire can be about 1 mm, within manufacturing and/or measurement tolerances. The width and thickness directions are the directions perpendicular to the direction of the extension of the wire, i.e. perpendicular to the direction the current flows in. The width direction is the larger dimension of the wire perpendicular to the extension of the wire, and the thickness direction is the smaller dimension of the wire perpendicular to the extension of the wire.

In a first example embodiment, the flat wire includes a width of 15±2 mm, and a thickness of 1.0±0.2 mm, for example. In a second example embodiment, the flat wire includes a width of 10±2 mm and a thickness of 1.0±0.2 mm, for example.

The dimensions of the flat wire above may be used with any conductive material, such as copper. However, the dimensions above are specifically tailored to achieve the maximal beneficial effects, such as the cooling benefit, when aluminum is used as the conductive material.

In some example embodiments, a mix of conductive materials may be used, for example different conductive materials may be used in each of the primary and secondary coils.

FIG. 14 is a graph showing the maximum operating power as the operating voltage and the frequency are varied for an electrical transformer using both the hybrid construction and the winging arrangements described herein. In FIG. 14, the winding arrangement shown in FIG. 7A was used. As can be seen from FIG. 14, the electrical transformer can handle a power of between about 50 kW to about 100 kW across the majority of the voltage range of about 100 V to about 1100 V and the frequency range of about 10 kHz to about 100 kHz, for example. As can be seen in the graph in FIG. 14, in some regions the electrical transformer can handle up to double the rated power of about 50 kW, for example.

The hybrid transformer construction of FIGS. 2A to 6 and the winding arrangements of FIGS. 7A to 13 both contribute to providing a more adaptable transformer capable of handling at least about 50 kW over the above-mentioned voltage and frequency ranges, for example. Specifically, the hybrid construction of FIGS. 2A to 6 allows for both the winding unit and the cooling arrangement to be easily changed. The semi-open hybrid construction also improves the cooling when dealing with higher power levels. Moreover, the winding arrangement allows for multiple secondary coils to be used while retaining a compact structure and small footprint, allowing a transformer including the winding arrangement to power multiple circuits and/or to provide redundancy in both high- and low-current applications.

Moreover, in each of the example embodiments described above, where multiple secondary coils are used, when the winding arrangement is used in a transformer, two or more of the secondary coils may be connected together in series, or may be connected together in parallel, or may be connected together using a combination of series and parallel connections. For example, the two secondary coils 802, 804 shown in FIGS. 8A, 8B, and 9E may be connected in series or parallel in some example embodiments, or in another example embodiment some or all of the secondary coils shown in each of FIGS. 10A to 12C may be connected together in series or parallel or a combination thereof. Many permutations of series and parallel connections are possible and may be selected based on the specific application of the transformer.

By modifying the series and parallel connections between the secondary coils (when multiple secondary coils are present in the winding arrangement) the transformer can be adjusted to be used over a larger voltage and frequency range. For example, in some example embodiments, a transformer using the winding arrangements with multiple secondary coils as described above can be used in the voltage range of about 100 V to about 1100 V, and the frequency range of about 5 kHz to about 120 kHz, for example. In other words, modifying the series and parallel connections of the secondary coils allows the winding arrangement to be swapped between a high-current, low-voltage situation or a low-current, high-voltage situation, depending on the series and/or parallel connections made between the secondary coils. Therefore, only minor adjustments are needed to these series and parallel connections to make the transformer universal over the desired power level, for example, about 50 kW to about 100 kW.

Previous attempts to provide a universal transformer include using different core sizes and/or core assemblies to make the transformer suitable for different voltage and frequency levels. This is not necessary with the above-described hybrid transformer construction and winding arrangements.

In general, the above-described concepts and example embodiments may be applied to all high-power, high-frequency transformers including those with higher or lower power ratings than about 50 kW, for example. Moreover, the concepts described herein could also be used in high-power inductors or the like.

In use in a transformer, the connection terminals of the primary coil of the winding arrangements described above act as input terminals for an alternating current (AC) voltage source. This will result in an AC voltage being produced at the connection terminals of the one or more secondary coil (s). In other words, the connection terminals of the one or more secondary coil(s) act as output terminals. A load may be connected across the output terminals. In some example embodiments, by varying the number of turns in each coil, a step-up or step-down in voltage can be achieved.

Transformers according to example embodiments of the present invention may be used individually or as a bank of connected or unconnected transformers. Transformers according to example embodiments of the present invention may be used in various applications, such as use in a vehicle, for example in a regenerative braking system, or in power generation equipment, particularly in renewable energy systems, or in DC-DC converters, power inverters, radio frequency electronic equipment, or in miniature scale transformers. It is noted that this list is not intended to be exhaustive, and that other applications are also contemplated.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electrical transformer comprising:
a transformer core;
a winding arranged around the transformer core, the winding including a primary coil and a secondary coil encased in a potting material; and
a housing surrounding the transformer core and the winding, the housing including a plurality of thermal conductors in thermal contact with the winding and/or the transformer core, and the housing including one or more open sides such that the winding is exposed.

2. The electrical transformer according to claim 1, wherein the one or more open sides include two open sides located on opposing sides of the housing that expose the winding at both of the opposing sides of the housing.

3. The electrical transformer according to claim 2, wherein the two open sides expose a portion of each of the plurality of thermal conductors.

4. The electrical transformer according to claim 1, wherein the electrical transformer is cuboid or substantially cuboid in shape, and each of the one or more open sides extends across an entire surface of the electrical transformer.

5. The electrical transformer according to claim 1, wherein the housing includes an upper panel and a lower panel located on opposing sides of the electrical transformer.

6. The electrical transformer according to claim 5, wherein the upper panel and lower panel extend in planes normal or approximately normal to a winding axis of the winding.

7. The electrical transformer according to claim 5, wherein the upper panel and the lower panel are in contact with the transformer core.

8. The electrical transformer according to claim 5, wherein the plurality of thermal conductors includes a first set of thermal conductors that extend between the upper panel and the lower panel and that are in thermal contact with the upper panel and lower panel.

9. The electrical transformer according to claim 8, wherein each of the first set of thermal conductors is releasably secured to the upper panel at a first end, and releasably secured to the lower panel at a second end.

10. The electrical transformer according to claim 8, wherein
the plurality of thermal conductors includes a second set of thermal conductors located between the upper panel and the winding and in thermal contact with the upper panel and the winding; and/or
the plurality of thermal conductors includes a third set of thermal conductors located between the lower panel and the winding and in thermal contact with the lower panel and the winding.

11. The electrical transformer according to claim 10, wherein
each of the second set of thermal conductors is releasably secured to the upper panel; and/or
each of the third set of thermal conductors is releasably secured to the lower panel.

12. The electrical transformer according to claim 10, further comprising:
one or more additional thermal conductors located against a central portion of the transformer core, wherein each of the one or more additional thermal conductors extends between the upper panel and the lower panel and is in thermal contact with the upper panel and lower panel; wherein
the winding is arranged around the transformer core and the additional thermal conductors.

13. The electrical transformer according to claim 12, wherein the one or more additional thermal conductors are integral with the winding.

14. The electrical transformer according to claim 12, wherein
the housing includes gaps between the first set of thermal conductors and the third set of thermal conductors; and/or
the housing includes gaps between the second set of thermal conductors and the one or more additional thermal conductors.

15. The electrical transformer according to claim 1, wherein the transformer core includes:
one or more core layers, wherein each of the one or more core layers includes two closed cores, and each of the two closed cores includes either two U-shaped cores or a U-shaped core and an I-shaped core; and
a thermally conductive plate that is located between the two closed cores and extends along a winding axis of the winding so as to bisect the one or more core layers.

16. The electrical transformer according to claim 1, wherein the transformer core includes:
one or more core layers, wherein each of the one or more core layers includes one closed core including either two U-shaped cores or a U-shaped core and an I-shaped core; and
a thermally conductive plate that is located on one side of the transformer core and extends along a winding axis of the winding.

17. The electrical transformer according to claim 5, further comprising a pair of protrusions extending from the winding and configured to engage with the transformer core, with a portion of the transformer core located between the pair of protrusions.

18. The electrical transformer according to claim 17, wherein the pair of protrusions extend between the winding and the lower panel.

19. The electrical transformer according to claim 17, wherein the pair of protrusions are defined by the potting material.

20. The electrical transformer according to claim 1, wherein the plurality of thermal conductors prevents movement of the winding within the housing.

21. The electrical transformer according to claim 1, wherein
the primary coil and the secondary coil each include a first section and a second section, and each of the first and the second sections include a first set of turns including a first diameter and a second set of turns including a second diameter;
the first diameter is larger than the second diameter;
the first section and the second section of the primary coil are electrically connected in parallel and are wound around a common winding axis, with the second set of turns of the second section positioned within the first set of turns of the first section, and the second set of turns of the first section positioned within the first set of turns of the second section, when viewed along the common winding axis;
the first section and the second section of the secondary coil are electrically connected in parallel and are wound around the common winding axis, with the second set of turns of the second section positioned within the first set of turns of the first section, and the second set of turns of the first section positioned within the first set of turns of the second section, when viewed along the common winding axis; and
turns of the primary coil are interleaved with turns of the secondary coil.

22. The electrical transformer according to claim 1, wherein the winding further includes a plurality of additional secondary coils.

23. The electrical transformer according to claim 5, wherein the winding includes connection points for the primary coil and the secondary coil that extend through the upper panel.

24. The electrical transformer according to claim 5, wherein the lower panel is a cold plate or is in thermal contact with a cold plate.

25. The electrical transformer according to claim 1, wherein one or more of the plurality of thermal conductors includes radiating fins.

26. The electrical transformer according to claim 1, wherein
one or more of the plurality of thermal conductors include aluminium; and/or
one or more of the plurality of thermal conductors include at least one outer surface that is black.

27. The electrical transformer according to claim 1, further comprising one or more winding cooling plates; wherein
each of the one or more winding cooling plates is in thermal contact with an upper or a lower surface of the winding; and
each of the one or more winding cooling plates is in thermal contact with at least one of the plurality of thermal conductors.

28. The electrical transformer according to claim 1, wherein
the plurality of thermal conductors includes a first pair of thermal conductors located in thermal contact with an upper surface of the winding; and/or
the plurality of thermal conductors includes a second pair of thermal conductors located in thermal contact with a lower surface of the winding.

29. The electrical transformer according to claim 28, further comprising:
one or more first winding cooling plates located between the upper surface of the winding and the first pair of thermal conductors; and/or
one or more second winding cooling plates located between the lower surface of the winding and the second pair of thermal conductors.

30. The electrical transformer according to claim 29, wherein each of the one or more first winding cooling plates and of the one or more second winding cooling plates extends in a direction parallel or substantially parallel to a plane of the winding and extends through the transformer core in a direction perpendicular or substantially to a plane of the transformer core.

31. The electrical transformer according to claim 29, wherein each of the one or more first winding cooling plates and of the one or more second winding cooling plates extends between a pair of the plurality of thermal conductors positioned on opposing sides of the transformer core.
